(19) United States
(12) Patent Application Publication
(10) Pub. No.: US 2008/0244067 A1
(43) Pub. Date: Oct. 2, 2008

(54) Contents distribution system and information processing method thereof, as well as contents management apparatus and recording medium on which program thereof is recorded

(75) Inventor: Kentaro Ushiyama, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/073,785

(22) Filed: Mar. 10, 2008

(30) Foreign Application Priority Data
Mar. 29, 2007 (JP) 2007-089814

(51) Int. Cl. G06F 15/173; G06F 15/16

(52) U.S. Cl. 709/224; 709/232

(57) ABSTRACT

To appropriately adjust a number of contents data which are transmitted and received among terminal apparatus, in a peer-to-peer type contents distribution system including a plurality of terminal apparatus mutually connected via a network.

A contents distribution system, configured of a plurality of terminal apparatus disposed in a network, which carries out a transmission and reception of contents data among the terminal apparatus, includes a terminal apparatus number detection unit, which detects a number of the terminal apparatus configuring the contents distribution system, a contents number determination unit, which determines a number of contents data which can be transmitted and received among the terminal apparatus, based on the number of the terminal apparatus detected by the terminal apparatus number detection unit, and a contents number adjustment unit, which changes the number of contents data which can be transmitted and received among the terminal apparatus, in accordance with the number of contents data determined by the contents number determination unit.

### CROSS-REFERENCE TO RELATED APPLICATIONS

This application is based on and claims the benefit of priority from Japanese Patent Application No. 2007-089814 filed on Mar. 29, 2007; the entire contents of which are incorporated -herein by reference.

### BACKGROUND OF THE INVENTION

1. Field of the Invention

The present invention relates to a technological field of a peer-to-peer (P2P) type contents distribution system, which includes a plurality of terminal apparatus mutually connected via a network.

2. Description of the Related Art

In recent years, a so-called contents distribution system, which distributes contents data such as music, a movie, or a talk program, via a network such as an internet, has been an active area of research.

Then, a technology has been proposed for efficiently distributing and disposing information, such as contents data, to achieve a load distribution, by logically constructing an overlay network using a DHT (Distributed Hash Table).

In this kind of contents distribution system, each terminal apparatus, rather than recognizing link information (for example, an IP address) for all terminal apparatus participating in the overlay network, holding only link information for one portion of the terminal apparatus acquired when participating, or the like, carries out a search, or the like, for the contents data, based on such link information (refer to Japanese Unexamined Patent Publication No. 2006-197400).

### SUMMARY OF THE INVENTION

However, in this kind of contents distribution system, when contents data transmitted and received among the terminal apparatus increase, it is necessary to increase a storage capacity to hold the contents data in the terminal apparatus overall.

However, in the event that there is a restriction on the storage capacity of the terminal apparatus, a supply volume is insufficient with respect to a contents data demand volume in the contents distribution system. In the event that the supply volume is insufficient in this way, a situation occurs in which a transmission and reception of the contents data among the terminal apparatus is impossible.

Therein, there is a method which provides a contents supply apparatus in order that the supply volume satisfies the demand volume. That is, in response to a request from a terminal apparatus which cannot acquire desired contents data by the transmission and reception among the terminal apparatus, a contents supply apparatus is provided which transmits the contents data to the terminal apparatus which has made the request.

However, in the case in which a contents supply apparatus is disposed in this way, in the event that a supply capability in the contents distribution system is still more insufficient, there occurs a load concentration on the contents supply apparatus. In this way, in the heretofore described contents distribution system, a number of contents data which can be supplied is restricted. That is, in a case in which a number of terminal apparatus becomes low with respect to the number of contents data, the supply volume becomes low with respect to the contents data demand volume, and there is a possibility of it being impossible to supply the contents data, even in the case of disposing a contents supply apparatus.

The invention being contrived bearing in mind the heretofore described disadvantages, the present inventor has recognized the need to provide, in a peer-to-peer type contents distribution system including a plurality of terminal apparatus mutually connected via the network, a contents distribution system and method, and the like, which can appropriately adjust a number of contents data which are transmitted and received among the terminal apparatus.

Therein, according to an aspect of the invention, a contents management apparatus which manages contents in a contents distribution system, configured of a plurality of terminal apparatus disposed in a network, which carries out a transmission and reception of contents data among the terminal apparatus, includes: a terminal apparatus number detection unit which detects a number of the terminal apparatus configuring the contents distribution system; a contents number determination unit which determines a number of contents data which can be transmitted and received among the terminal apparatus, based on the number of the terminal apparatus detected by the terminal apparatus number detection unit; and a contents number adjustment unit which changes the number of contents data which can be transmitted and received among the terminal apparatus, in accordance with the number of contents data determined by the contents number determination unit.

### BRIEF DESCRIPTION OF THE DRAWINGS

FIG. 1 is a diagram showing one example of a connection aspect of each terminal apparatus in a contents distribution system according to an embodiment;

FIG. 2 is an illustration of an ID space;

FIGS. 3A and 3B are diagrams showing an appearance of a routing table compiled by a DHT;

FIG. 4 is one example of a routing table;

FIG. 5 is a diagram showing one example of an appearance of a terminal apparatus, which is a contents data holding source, being searched for by the DHT;

FIGS. 6A and 6B are diagrams showing an appearance of a contents holding terminal registration message being forwarded, represented in a spanning tree form;

FIG. 7 is one example of a terminal apparatus index table;

FIG. 8 is a diagram for illustrating an outline of a contents data acquisition and reproduction operation in the terminal apparatus;

FIG. 9 is a diagram for illustrating an outline of a contents data acquisition and reproduction operation in the terminal apparatus;

FIG. 10 is a diagram showing an example of a relationship between a server load and a participating terminal number, graphed for each contents number;

FIG. 11 is a diagram showing an outline configuration example of the terminal apparatus;

FIG. 12 is a diagram showing an outline configuration example of a contents supply apparatus;

FIG. 13 is a diagram showing an outline configuration example of a contents management apparatus;

FIG. 14 is a table in which are correlated the participating terminal number and a disclosed contents number;

FIG. 15 is a flowchart showing a main process in the terminal apparatus;

FIG. 16 is a flowchart showing a contents acquisition and reproduction process in the terminal apparatus;

FIG. 17 is a flowchart showing a contents transmission process in the terminal apparatus;

FIG. 18 is a flowchart showing a main process in the contents supply apparatus;

FIG. 19 is a flowchart showing a main process in the contents management apparatus;

FIG. 20 is a flowchart showing a contents list update process in the contents management apparatus;

FIG. 21 is a flowchart showing a main process in the contents management apparatus; and

FIG. 22 is a flowchart showing a contents list update process in the contents management apparatus.

### DESCRIPTION OF THE PREFERRED EMBODIMENTS

Hereafter, a description will be given, based on the drawings, of preferred embodiments of the invention. The embodiments to be described hereafter are embodiments of cases in which the invention is applied to a contents distribution system, which has contents data such as music data and movie data as information to be distributed.

### 1. First Embodiment

### 1.1. Configuration and the Like of Contents Distribution System S

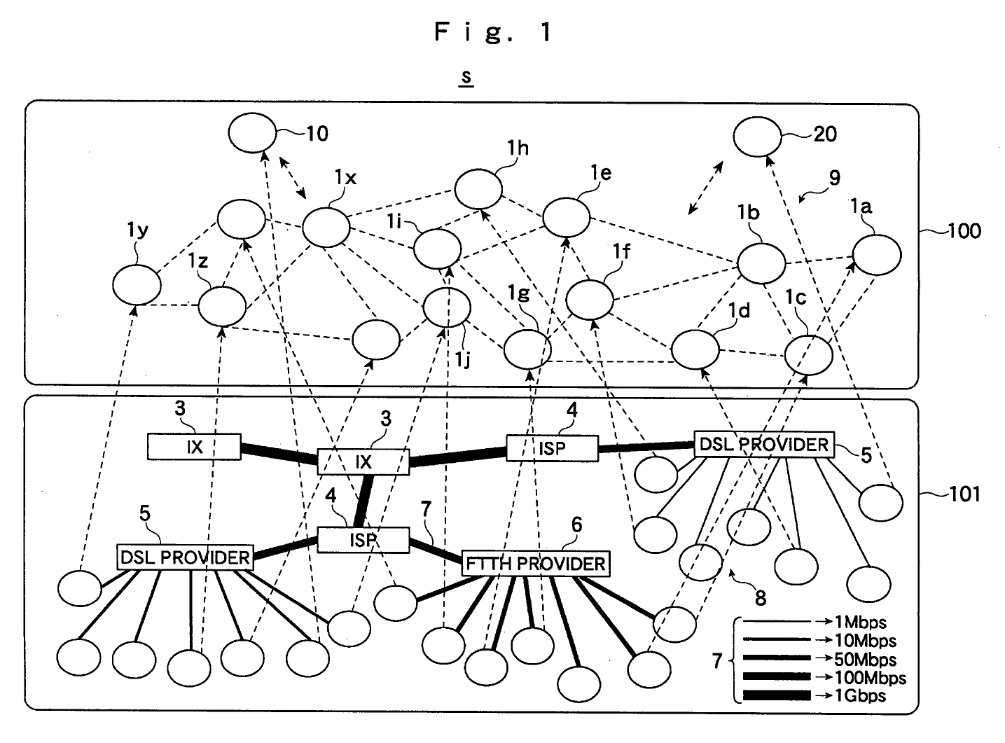

Firstly, a description will be given of an outline configuration and the like of a contents distribution system S according to the embodiment, referring to FIG. 1. FIG. 1 is a diagram showing an example of a connection aspect of each terminal apparatus in the contents distribution system S according to the embodiment. The contents distribution system S, being configured of a plurality of terminal apparatus disposed distributed on a network, carries out a transmission and reception of contents data between the terminal apparatus.

As shown within a lower frame 101 of FIG. 1, a network (a network in the actual world) 8, such as an internet, is constructed of an IX (Internet exchange) 3, an ISP (Internet Service Provider) 4, a DSL (Digital Subscriber Line) provider (a device thereof) 5, an FTTH (Fiber To The Home) provider (a device thereof) 6, and a communication line 7 (for example, a telephone line, an optical cable, or the like).

As shown within an upper frame 100 of FIG. 1, the contents distribution system S, being configured including a plurality of terminal apparatus 1a, 1b, 1c . . . 1x, 1y, 1z . . . mutually connected via the network 8, is a peer-to-peer (P2P) type of network system. A unique manufacturing number (for example, a MAC address) and IP (Internet Protocol) address are allotted, as information indicating a terminal apparatus, to each terminal apparatus 1a, 1b, 1c . . . 1x, 1y, 1z . . . . The manufacturing number and IP address are not duplicated among the plurality of terminal apparatus. Also, in the following description, in a case of indicating any one terminal apparatus among the terminal apparatus 1a, 1b, 1c . . . 1x, 1y, lz . . . , or all of the terminal apparatus, it or they may be referred to as the terminal apparatus 1, for the sake of convenience.

### 1.1.1. DHT Outline

Hereafter, a description will be given of an algorithm using a distributed hash table (hereafter called a “DHT”) according to the embodiment.

In the heretofore described contents distribution system S, when terminal apparatus 1 exchange information with each other, they have to know each other's IP address, which is location information.

For example, in a system in which contents are shared, although each terminal apparatus 1 participating in the network 8 knows the IP addresses of all other terminal apparatus 1 participating in the network 8 by a simple method, in the event that a number of terminal apparatus rises to several tens of thousands, or several hundreds of thousands, it is not realistic to attempt to remember the IP addresses of all the terminal apparatus 1. Also, in the event that power of an optional terminal apparatus 1 is frequently turned on or off, the IP address of the optional terminal apparatus 1 stored in each terminal apparatus 1 being updated frequently, operation becomes difficult.

Therein, only the IP addresses of a minimally necessary portion of terminal apparatus 1, among all the terminal apparatus 1 participating in the network 8, being stored in one terminal apparatus 1, regarding terminal apparatus 1 of which the IP addresses are not stored, a system is being considered whereby contents are delivered by forwarding information amongst the terminal apparatus 1.

As one example of this kind of system, a kind of overlay network 9 shown within the upper frame 100 of FIG. 1 is constructed by the algorithm using the DHT. That is, the overlay network 9 refers to a network configuring a virtual link formed using the already existing network 8.

In the embodiment, with the overlay network 9 constructed by the algorithm using the DHT as a precondition, terminal apparatus 1 disposed on the overlay network 9 are referred to as terminal apparatus participating in the contents distribution system S (in other words, participating in the overlay network 9).

A unique number is given to each terminal apparatus 1 as terminal ID, which is an identification number of each terminal apparatus 1 participating in the contents distribution system S. It is necessary to give this number a number of bits equivalent to a maximum operational number of terminal apparatus which can be accommodated. For example, in a case of a number of 128 bits, it is possible to operate 2¹²⁸ (2 to the power of 128)≈340×10³⁶ (10 to the power of 36) terminal apparatus.

More specifically, the terminal ID's of each terminal apparatus 1, being hash values obtained by hashing a value unique to each terminal apparatus 1, such as the IP address or manufacturing number of each terminal apparatus 1, with a common hash function (a hash algorithm), are disposed, distributed without bias, in one ID space.

As long as the relevant IP address or manufacturing number differs, a probability of terminal ID calculated by hashing with the common hash function in this way having the same value is extremely low. As the hash function is public knowledge, a detailed description will be omitted. Also, in the embodiment, a value of the IP address (a global IP address) hashed with the common hash function will be taken as the terminal ID.

Also, in the plurality of terminal apparatus 1 participating in the contents distribution system S, although contents data (for example, music data, movie data, document data, or the like), as common information distributed from one terminal apparatus 1 to other terminal apparatus 1, are stored distributed, an identification number (hereafter called “contents ID”), unique to each item of contents data, is given to the contents data too.

Then, the contents ID is made the same length as the terminal ID (for example, 128 bits, or the like), and a contents name (for example, a data file name) or the like is hashed with the common hash function when the terminal ID is acquired (that is, it is disposed in the same ID space as the hash value of the terminal apparatus 1 IP address).

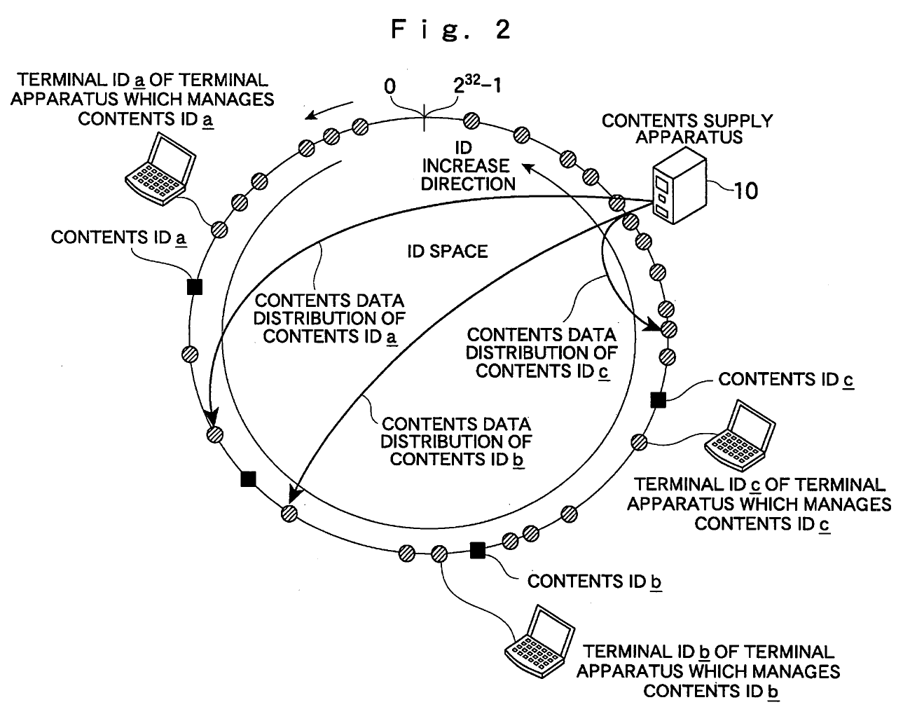

In this way, as the terminal ID and contents ID, given respectively to each terminal apparatus 1 and each item of contents data, are generated by the common hash function, it is possible to think of them existing scattered, with no particular bias, on one ring-shaped ID space, as shown in FIG. 2. The figure illustrates the terminal ID and contents ID given at 32 bits. In the figure, round marks indicate the terminal ID, and squares the contents ID, and the ID increase in a counter-clockwise direction.

In the embodiment, as heretofore described, a rule being applied to the effect that “a terminal apparatus managing contents data which have a certain contents ID is a terminal apparatus which has a terminal ID near the contents ID”, a definition of “near” is that, without exceeding the contents ID, a difference between the contents ID and the terminal ID is the smallest, although in practice another definition is also acceptable, as long as it is consistent when allotting a management of the contents data to the terminal apparatus 1.

In the example shown in FIG. 2, based on the definition, a contents ID a is managed by a terminal apparatus 1 having a terminal ID near the contents ID a (hereafter called a “terminal ID a”), a contents ID b is managed by a terminal apparatus 1 having a terminal ID near the contents ID b (hereafter called a “terminal ID b”), and a contents ID c is managed by a terminal apparatus 1 having a terminal ID near the contents ID c (hereafter called a “terminal ID c”).

Herein, “managed” means, not that the terminal apparatus 1 is holding the contents data, but that “it knows which terminal apparatus 1 the contents data are being held in”. That is, it means that the terminal apparatus 1 holds information (an IP address, which is location information of a contents holding terminal apparatus) linking to a terminal apparatus 1 (hereafter called a “contents holding terminal apparatus”) holding contents data transmitted and received within the contents distribution system S. For example, in FIG. 2, the terminal apparatus 1 which has the terminal ID a knows in which of the terminal apparatus 1 the contents data having the contents data ID a are being held, and the terminal apparatus 1 which has the terminal ID b, and the terminal apparatus 1 which has the terminal ID c, also know, in the same way, in which of the terminal apparatus 1 the contents data having the contents data ID b, and the contents data having the contents data ID c, respectively are being held.

In this way, the terminal apparatus 1 which knows in which of the terminal apparatus 1 certain contents data are being held is called a root terminal apparatus of those contents data. That is, the terminal apparatus 1 which has the terminal ID a is the root terminal apparatus of the contents data having the contents ID a, the terminal apparatus 1 which has the terminal ID b is the root terminal apparatus of the contents data having the contents ID b, and the terminal apparatus 1 which has the terminal ID c is the root terminal apparatus of the contents data having the contents ID c.

Also, as shown in FIGS. 1 and 2, a contents supply apparatus 10, as a contents supply unit having a function introducing contents data into the contents distribution system S, that is, a function distributing contents data, in order to make a terminal apparatus 1 within the contents distribution system S a contents holding terminal apparatus, to the terminal apparatus 1, and a function transmitting contents data in response to a request from a terminal apparatus 1, and a contents management apparatus 20, having a function generating a contents list (a catalog), which is a list of contents data able to be transmitted and received among the terminal apparatus in the contents distribution system S, and providing it to the terminal apparatus 1, and a function transmitting a contents key (corresponding to one example of key information), for reproducing or acquiring contents data in response to a request from a terminal apparatus 1, and the like, and managing the contents, are provided in the contents distribution system S. “Introducing contents into the contents distribution system S” means that the contents supply apparatus 10 determines a terminal apparatus 1 which is to be a first contents holding terminal apparatus for certain contents data, and distributes the contents data to the determined terminal apparatus 1. A “contents data number”, being a number of all the contents data included in the contents list, is a publicly disclosed contents number.

### 1.1.2. Routing Table Compilation

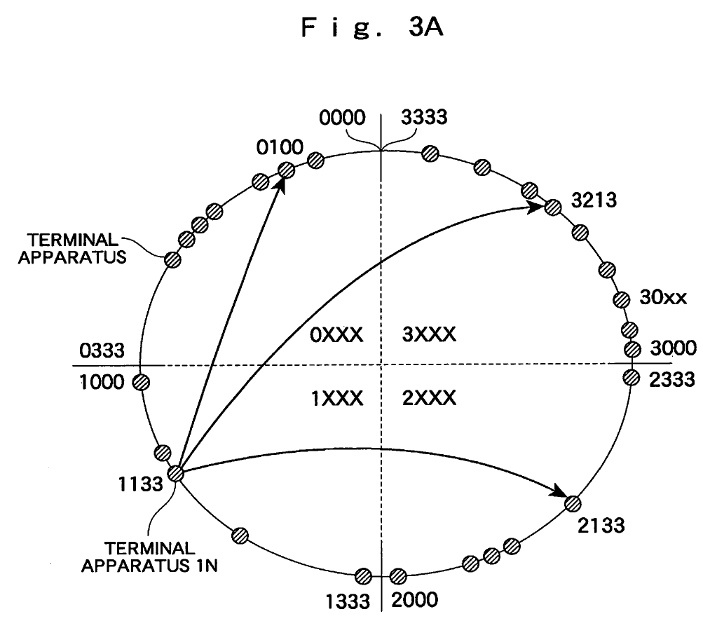

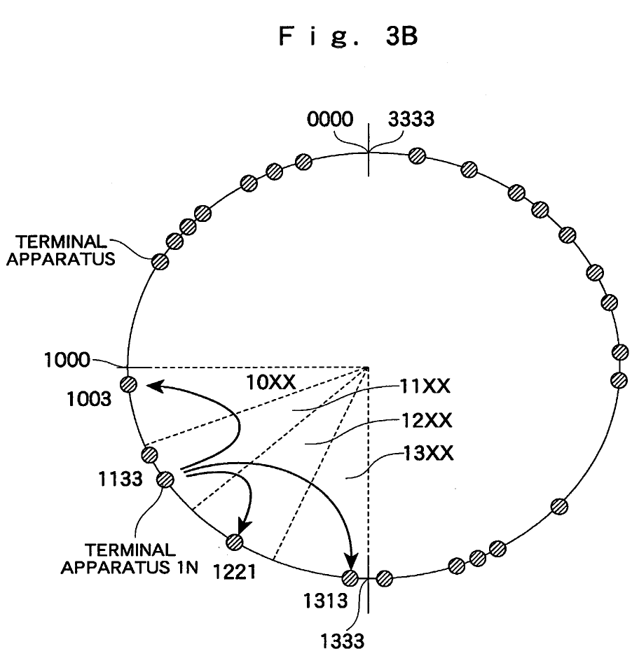

Herein, referring to FIGS. 3A and 3B, a description will be given of one example of a method of compiling a routing table used in the DHT. FIGS. 3A and 3B show one example of an aspect of a routing table compiled by the DHT.

Firstly, as shown in FIG. 3A, an ID space is divided into a number of areas. Although, in practice, a 16-division scale is often used, four divisions will be used here, in order to simplify the description, and ID's will be expressed in bit lengths of eight bits in base four. Then, taking terminal ID of a terminal apparatus 1N to be “1133”, a description will be given of an example of making a routing table of the terminal apparatus 1N.

Level 1 Routing

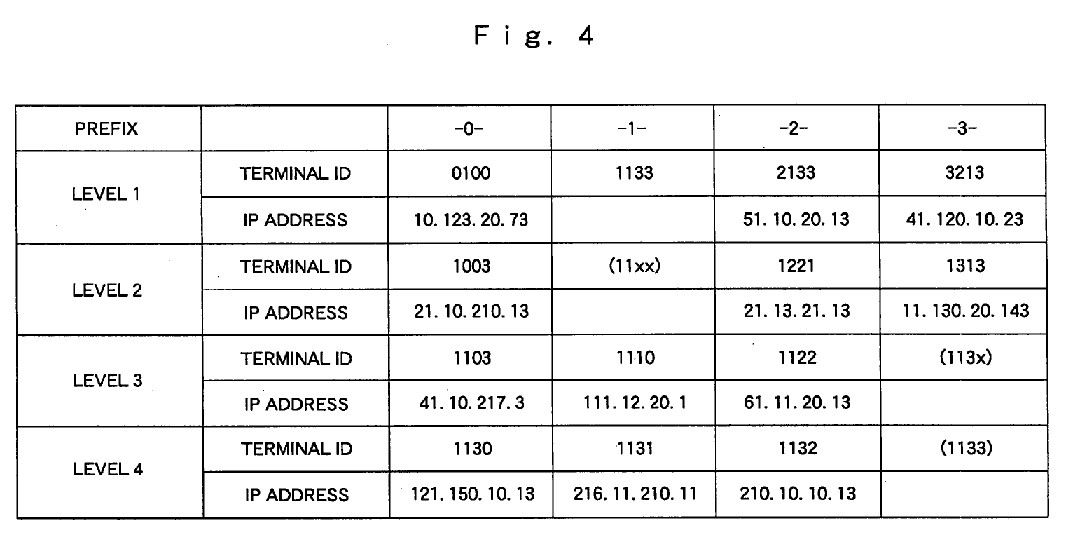

Firstly, in a case of dividing the ID space into four, it is divided into four areas, “0XXX”, “1XXX”, “2XXX” and “3XXX” (X is a positive integer between 0 and 3 inclusive, the same applying hereafter), of which first digits differ when each area is expressed in base four. The terminal apparatus 1N, terminal ID of the terminal apparatus 1N itself being “1133”, exists in the area “1XXX” in a bottom left in FIG. 3A. Then, the terminal apparatus 1N, from information and the like transmitted from another terminal apparatus 1, or the like, which has received a participation request, selects a terminal apparatus 1 existing in an area (that is, the area “0XXX”, the area “2XXX” or the area “3XXX”) other than the area in which it exists itself (that is, the area “1XXX”), and stores terminal ID and an IP address of the terminal apparatus 1 in a level 1 table. FIG. 4 is one example of the level 1 table. In the table, “0100” as terminal ID of the area “0XXX”, “2133” as terminal ID of the area “2XXX”, and “3213” as terminal ID of the area “3XXX”, each indicate a selected condition. As a second column of the level 1 shows the terminal apparatus 1N itself, it is not necessary to store an IP address.

Level 2 Routing

Next, as shown in FIG. 3B, of the four areas formed by the heretofore described routing, the terminal apparatus 1N further divides the area in which it exists itself (“1XXX”) in four, making it into four new areas, “10XX”, “11XX”, “12XX” and “13XX”. Then, in the same way as heretofore described, the terminal apparatus 1N appropriately selects a terminal apparatus 1 existing in an area other than the area in which it exists itself (“11XX”), and stores terminal ID and an IP address of the terminal apparatus 1 in a level 2 table. FIG. 4 is one example of the level 2 table. In the table, “1003” as terminal ID of the area “10XX”, “1221” as terminal ID of the area “12XX”, and “1313” as terminal ID of the area “13XX”, each indicate a selected condition. A second column of the level 2 being the area “11XX” in which the terminal apparatus 1N exists, an IP address is not stored, because it is tabulated in a level 3, to be described hereafter. Also, in the event that no terminal apparatus 1 exists in the heretofore described areas, terminal ID and IP address sections are empty.

Level 3 Routing

Furthermore, of the four areas formed by the heretofore described routing, the terminal apparatus 1N further divides the area in which it exists itself (“11XX”) in four, making it into four new areas, “110X”, “111X”, “112X” and “113X”. Then, in the same way as heretofore described, the terminal apparatus 1N appropriately selects a terminal apparatus 1 existing in an area other than the area in which it exists itself (“113X”), and stores terminal ID and an IP address of the terminal apparatus 1 in a level 3 table. FIG. 4 is one example of the level 3 table. A fourth column of the level 3 being the area in which the terminal apparatus 1N exists, an IP address is not stored, because it is tabulated in a level 4, to be described hereafter. Also, in the event that no terminal apparatus 1 exists in the heretofore described areas, the terminal ID and IP address sections are empty.

In this way, by compiling the routing table, as shown in FIG. 4, in the same way as far as the level 4, it is possible to encompass all the eight bit ID. Each time the level rises, empty spaces in the table stand out more.

All the terminal apparatus 1 individually compile and possess a routing table compiled in accordance with the heretofore described method. In this way, each terminal apparatus 1 has a routing table to which are correlated terminal ID and IP addresses, which are identification information of one portion of terminal apparatus 1 among the plurality of terminal apparatus 1 in the contents distribution system S.

### 1.1.3. Contents Data Search Method

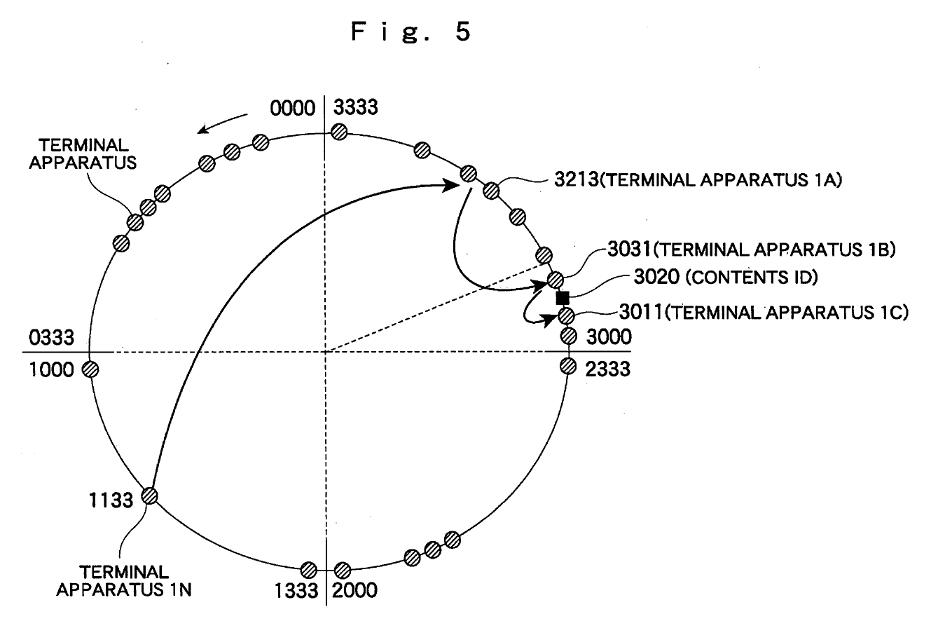

Next, referring to FIG. 5, a description will be given of one method of searching for a terminal apparatus 1 which is holding contents data. FIG. 5 shows one example of an appearance of a terminal apparatus 1, which is holding contents data, being searched for by the DHT.

Herein, a description will be given of a procedure when the terminal apparatus 1N with terminal ID “1133” searches for contents data which have a contents ID “3020”. Hereafter, a terminal apparatus 1 which searches for contents data, and requests a transmission of the contents data, in this way will be called a request terminal apparatus.

The request terminal apparatus 1N, making the contents ID “3020” destination identification information, refers to the routing table which it is holding itself, and transmits a request for a transmission (hereafter called a “search message”) of contents holding terminal apparatus identification information. Supposing that the request terminal apparatus 1N has a routing table of the same values as the example of FIG. 4, the contents ID “3020” being in the area “3XXX”, it transmits the search message to, among terminal apparatus 1 belonging to the area “3XXX”, a terminal apparatus 1A (contents ID “3213”) of which it knows an IP address (that is, of which the IP address is stored in the routing table which it is holding itself). In this way, the search message including the contents ID, which is unique identification information corresponding to the contents data, the contents ID is used as the destination identification information in the search message.

Next, the terminal apparatus 1A which has received the search message determines whether or not the search message is a message directed to the terminal apparatus 1A itself. The determination of whether or not it is a message directed to the terminal apparatus 1A itself is carried out based on the destination identification information and the routing table. Specifically, it is determined whether or not the destination identification information is near a terminal ID which is identification information of the terminal apparatus 1A itself. That is, the terminal apparatus 1A determines, from the terminal ID of the terminal apparatus 1 stored in the routing table (values of the table are not shown) which the terminal apparatus 1A itself is holding, whether the terminal apparatus 1 terminal ID nearest to the destination identification information is its own, or that-of another terminal apparatus 1.

Then, as the terminal ID of another terminal apparatus 1 is nearer the destination identification information than the terminal ID of the terminal apparatus 1A itself, the terminal apparatus 1A refers to the level 2 table of the routing table which the terminal apparatus 1A itself is holding, and forwards the search message to, among terminal apparatus 1 belonging to the area “30XX”, a terminal apparatus 1B (contents ID “3031”) of which it knows an IP address.

In this way, the forwarding of the search message proceeding by a procedure of matching digits of the contents ID in order from a first digit, when eventually arriving at a terminal apparatus 1C which manages the contents data, that is, the route terminal apparatus, the route terminal apparatus searches for the contents ID “3020” included in the search message from among index information, to be described hereafter, which it manages itself, and returns information (a terminal ID, an IP address, and the like) relating to a contents holding terminal apparatus which possesses the contents data to the request terminal apparatus 1N. A system which forwards a message, such as the search message, in the heretofore described way until it arrives at an objective terminal apparatus 1 is called a DHT routing.

In this way, the request terminal apparatus 1N becoming aware of the IP address, which is location information relating to the contents holding terminal apparatus which holds the contents data with the contents ID “3020”, by receiving it from the root terminal apparatus 1C, acquires the contents data from the contents holding terminal apparatus.

### 1.1.4. Method of Registering in Index Table

A description will be given, referring to the drawings, of a method when, for example, in the contents distribution system S with this kind of configuration, a certain terminal apparatus 1 makes new contents data searchable for from another terminal apparatus 1 in the contents distribution system S. Herein, the description will be given taking a terminal apparatus known to hold the contents data to be a terminal apparatus 1M with a terminal ID “1301”, contents ID of the contents data to be “3020”, and a root terminal apparatus of the contents ID “3020” to be the terminal apparatus 1C with a terminal ID “3011”.

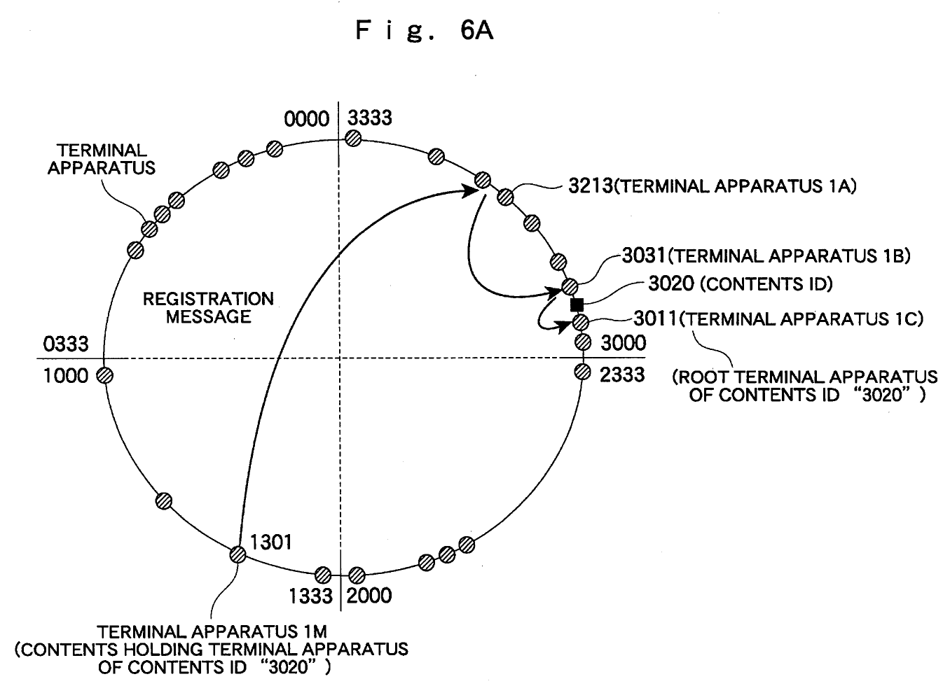

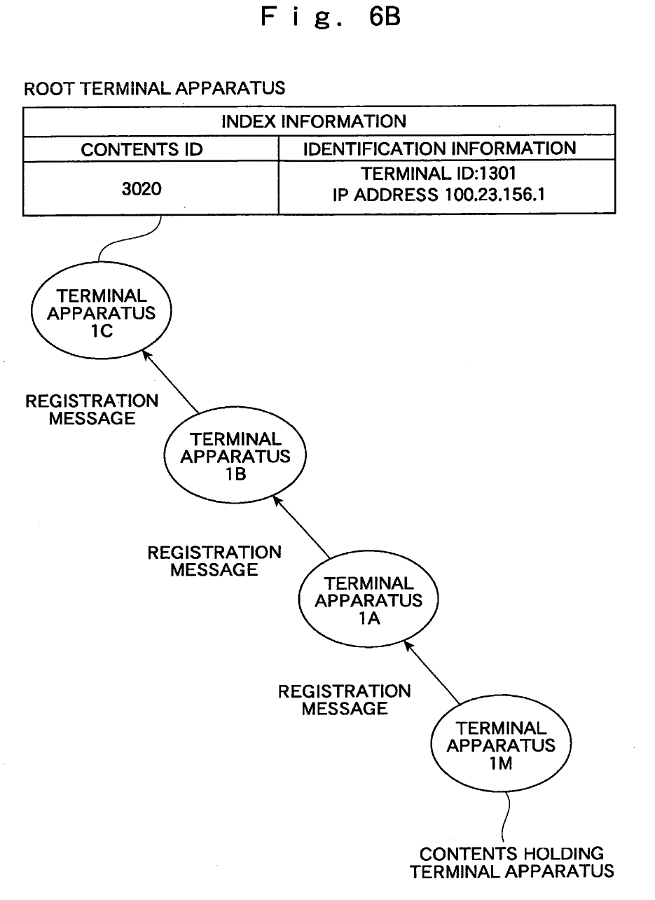

As shown in FIG. 6, the terminal apparatus 1M, which is known to be the contents holding terminal apparatus storing the contents data distributed from the contents supply apparatus 10, transmits a registration message (including the terminal ID of the terminal apparatus 1M, and an IP address and the contents ID “3020” thereof) toward a terminal apparatus 1 which has a terminal ID the same as the contents ID “3020” of the stored contents data (it is not known at this point whether or not this terminal apparatus 1 actually exists). Then, the registration message too, in the same way as the heretofore described search message, being forwarded on and on, in accordance with the routing table, when it has been forwarded as far as the terminal apparatus 1C, which has the terminal ID nearest the contents ID included in the registration message, in the event that the terminal apparatus 1C determines that there is no longer any other terminal apparatus 1 which is a forwarding destination, it determines that the terminal apparatus 1 itself should become the root terminal apparatus of the contents, and stores the contents ID, and the terminal ID and IP address of the contents holding terminal apparatus 1M (hereafter, these will be called the “index information”), included in the registration message.

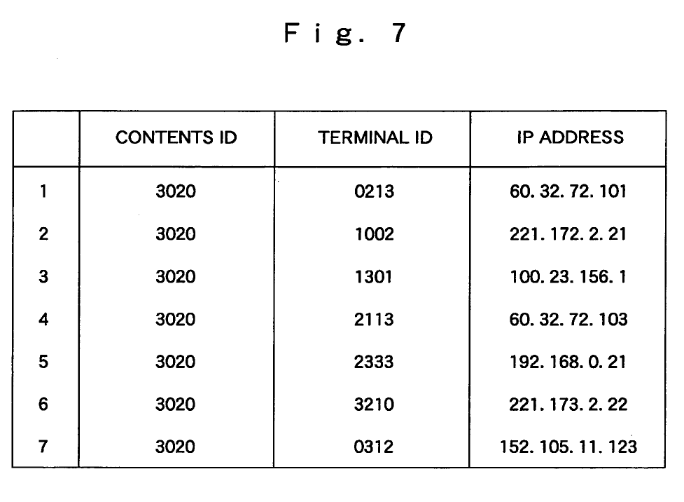

A holding of the index information in the root terminal apparatus is carried out by a kind of index table shown in FIG. 7. FIG. 7 showing an example of an index table in the root terminal apparatus 1C, the terminal apparatus 1 itself stores the terminal ID, IP address and the like of the contents holding terminal apparatus relating to the contents with the contents ID “3020”, which are a subject of management.

### 1.1.5. Outline of Contents Data Acquisition and Reproduction Operation in Terminal Apparatus 1

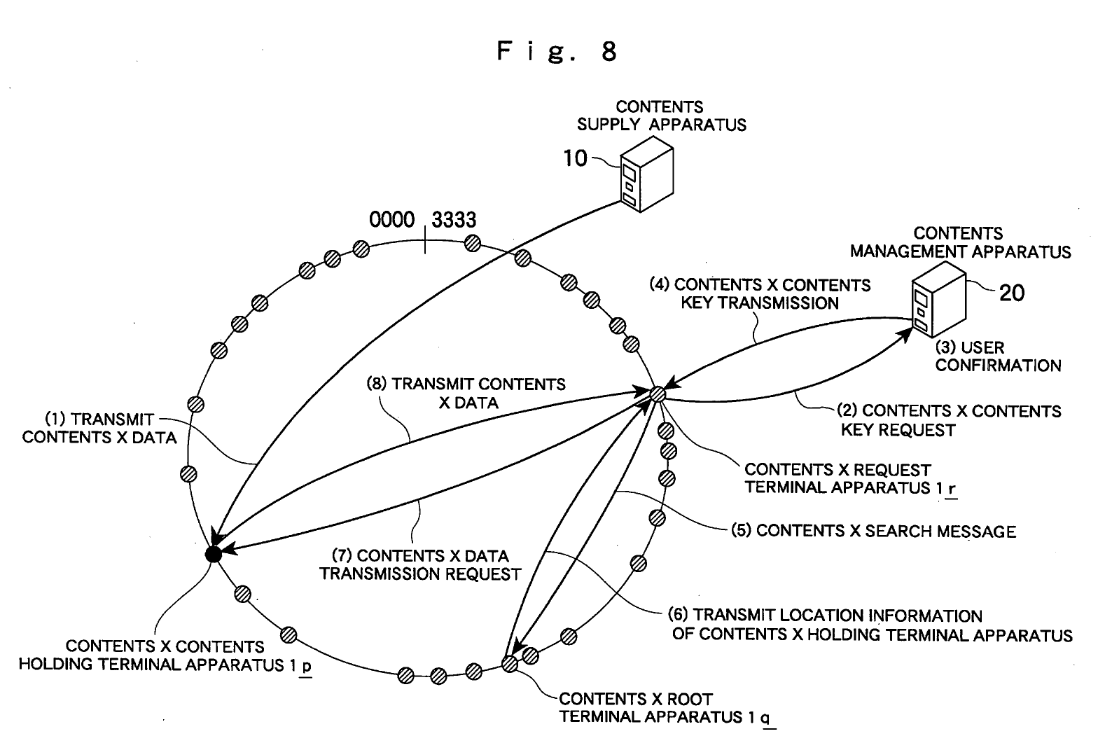

Next, a specific description will be given of an outline of a contents data acquisition and reproduction operation in the terminal apparatus 1 of the contents distribution system S. FIG. 8 is an illustration of the outline of the contents data acquisition and reproduction operation in the terminal apparatus 1. Herein, the description will be given exemplifying with a case in which contents data of certain contents X (hereafter called “contents X data”) are introduced into the contents distribution system S, and the contents X data are acquired and reproduced by the terminal apparatus 1. Also, in FIG. 8, a flow of the DHT routing is omitted, in order to simplify the description.

Normally, the request terminal apparatus acquires the contents X data from the contents holding terminal apparatus, and reproduces them (hereafter referred to as an “operation of acquiring from the contents holding terminal apparatus, and reproducing”) but, when it is not possible to transmit the contents X data to the request terminal apparatus, due to the contents holding terminal apparatus being in an overloaded condition or the like, the request terminal apparatus acquires the contents X data from the contents supply apparatus 10, and reproduces them (hereafter referred to as an “operation of acquiring from the contents supply apparatus, and reproducing”). Hereafter, each acquisition operation will be described in order.

Operation of Acquiring from Contents Holding Terminal Apparatus, and Reproducing

Firstly, a description will be given, referring to FIG. 8, of the operation whereby the request terminal apparatus acquires the contents data from the contents holding terminal apparatus. As shown in FIG. 8, in order to introduce the contents X data into the contents distribution system S, the contents supply apparatus 10 randomly determines a terminal apparatus 1 to which to distribute the contents X data. Herein, a number of terminal apparatus 1 to which the contents supply apparatus 10 distributes the contents X data is taken to be one, this is not limiting. For example, in the event that it can be predicted that the contents X data to be introduced will be popular contents, it is acceptable to increase the number.

Next, the contents supply apparatus 10 distributes the contents X data to the terminal apparatus 1 determined in the way heretofore described (herein taken to be a terminal apparatus 1r) (refer to 1 in FIG. 8). On the contents X data being distributed to the terminal apparatus 1p in this way, a transmission and reception of the contents X data among the terminal apparatus 1 becomes possible. That is, the terminal apparatus 1p, to which the contents X data are distributed, functions as the contents holding terminal apparatus. Although not shown, the terminal apparatus 1p, to which the contents X data are distributed, transmitting a registration message toward the root terminal apparatus of the contents X (herein taken to be a terminal apparatus 1q), the terminal apparatus 1p, by this means, registers index information including an IP address, which is location information of the terminal apparatus itself, and the like, in the root terminal apparatus 1q of the contents X.

Subsequently, on a user of a terminal apparatus 1 which is not the contents holding terminal apparatus (herein taken to be a terminal apparatus 1r) carrying out an operation (hereafter referred to as an “acquisition request operation”) in order to acquire the contents X data introduced into the contents distribution system S, the terminal apparatus 1r, as the request terminal apparatus, starts a contents X data acquisition operation.

In order to acquire the contents X data, the request terminal apparatus 1r, firstly, requests of the contents management apparatus 20 a transmission of a contents X contents key corresponding to the acquisition request operation (refer to 2 in FIG. 8).

A user list, for determining whether or not a user is legitimate, being stored in the contents management apparatus 20, the contents management apparatus 20 confirms whether or not the request terminal apparatus, which has requested the transmission of the contents X contents key, is a legitimate user (refer to 3 in FIG. 8).

A contents key corresponding to contents data which can be distributed within the contents distribution system S being stored in the contents management apparatus 20, in the event that it is determined that the request terminal apparatus 1r is a legitimate user, the contents management apparatus 20 retrieves the stored contents X contents key, and transmits it to the request terminal apparatus 1r (refer to 4 in FIG. 8).

The request terminal apparatus 1r, on receiving the contents X contents key transmitted from the contents management apparatus 20, transmits a search message, based on the routing table, in order to search for the contents holding terminal apparatus of the contents X (refer to 5 in FIG. 8).

The contents X root terminal apparatus 1q, which receives the search message, searches for an IP address, from its own index table, which is location information of the contents holding terminal apparatus holding the contents X data, and transmits a number of IP addresses of contents holding terminal apparatus found to the request terminal apparatus (refer to 6 in FIG. 8).

The request terminal apparatus, on receiving the number of IP addresses of contents holding terminal apparatus from the root terminal apparatus, makes one IP address among the IP addresses a destination, and makes a request to the contents X contents holding terminal apparatus (herein taken to be the terminal apparatus 1p) for a transmission of the contents X data (refer to 7 in FIG. 8).

The contents X contents holding terminal apparatus 1p, in response to the request from the request terminal apparatus, transmits the stored contents X data to the request terminal apparatus 1r in a streaming format (refer to 8 in FIG. 8).

The request terminal apparatus 1r receives the contents X data transmitted in the streaming format from the contents holding terminal apparatus 1p. The contents X data being encoded by a predetermined encoding method, the request terminal apparatus 1r decodes the contents X data by using the contents key received from the contents management apparatus 20 as a decoding key, and reproduces them streamed. Also, the request terminal apparatus 1r sequentially storing the received contents data in an internal memory, when it has stored all the contents data, it causes the terminal apparatus 1 itself to operate as the contents holding terminal apparatus, and transmits a registration message.

Operation of Acquiring from Contents Supply Apparatus, and Reproducing

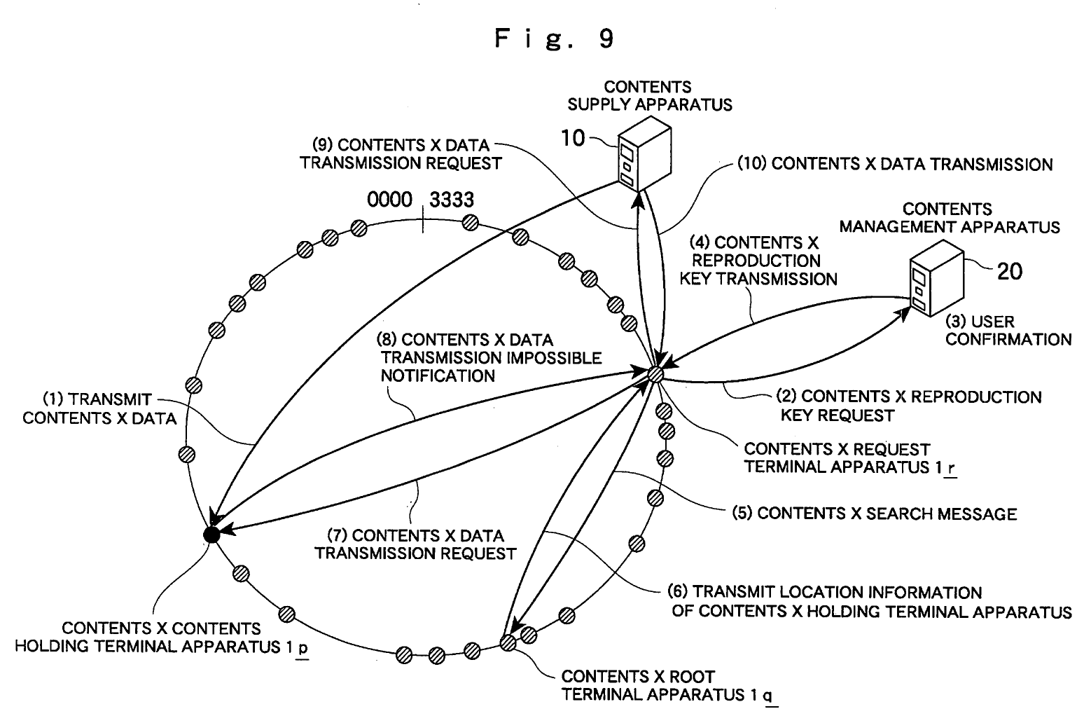

Next, a description will be given, referring to FIG. 9, of the operation whereby the request terminal apparatus acquires the contents data from the contents supply apparatus 10. In FIG. 9, an example is shown in which, in a case in which the contents holding terminal apparatus 1p cannot transmit the contents X data to the request terminal apparatus 1r due to a processing capability or the like in the contents holding terminal apparatus 1p (for example, such as when the contents holding terminal apparatus 1p, because it is transmitting a plurality of items of contents X data to other terminal apparatus, does not have a processing capability to supply the contents X data to the request terminal apparatus), the contents X data are acquired by the terminal apparatus 1, and reproduced. As processes 1 to 7 in FIG. 9 are the same as the processes 1 to 7 in FIG. 8, hereafter, a description will be given of processes 8 to 10 in FIG. 9.

As shown in FIG. 9, when the contents holding terminal apparatus 1p cannot transmit the contents X data to the request terminal apparatus 1r, due to the processing capability or the like of the contents holding terminal apparatus 1p, a notification to the effect that it is not possible to transmit the contents X data (a transmission impossible notification) is transmitted from the contents holding terminal apparatus 1p to the request terminal apparatus 1r (refer to 8 in FIG. 9).

The request terminal apparatus 1r, on receiving the transmission impossible notification from the contents holding terminal apparatus 1p, makes a request to the contents supply apparatus 10 for a transmission of the contents X data (refer to 9 in FIG. 9).

The contents supply apparatus 10, in response to the request from the request terminal apparatus 1r, transmits the stored contents X data to the request terminal apparatus 1r in the streaming format (refer to 10 in FIG. 9).

The request terminal apparatus 1r receives the contents X data transmitted in the streaming format from the contents supply apparatus 10. Thereafter, in the same way as when receiving the contents X data from the contents holding terminal apparatus 1p, the request terminal apparatus 1r decodes the contents X data by using the contents key received from the contents management apparatus 20 as the decoding key, and reproduces them streamed. Also, the request terminal apparatus 1r sequentially storing the received contents data in the internal memory, when it has stored all the contents data, it causes the terminal apparatus 1 itself to operate as the contents holding terminal apparatus, and transmits a registration message.

### 1.1.6. Processes in Accordance With Number of Terminal Apparatus 1 in Contents Distribution System S

Although, in the contents distribution system S in the embodiment, carrying out the transmission and reception of the contents data among the terminal apparatus is taken as a basic, as heretofore described, when it is not possible to supply the contents data from the contents holding terminal apparatus, the contents data are supplied from the contents supply apparatus 10.

However, there is a danger that, due to a relationship between a number of items of contents data in the contents distribution system S (hereafter, also called simply a “contents number”) and a number of terminal apparatus 1 in the contents distribution system S (hereafter, also called a “participating terminal number”), accesses concentrate in the contents supply apparatus 10. In the event that accesses concentrate in the contents supply apparatus 10 in this way, a process load of the contents supply apparatus 10 (hereafter called a “server load”) increases, and there is a danger that a situation arises in which its limit (hereafter taken to be a “server performance limit”) is reached.

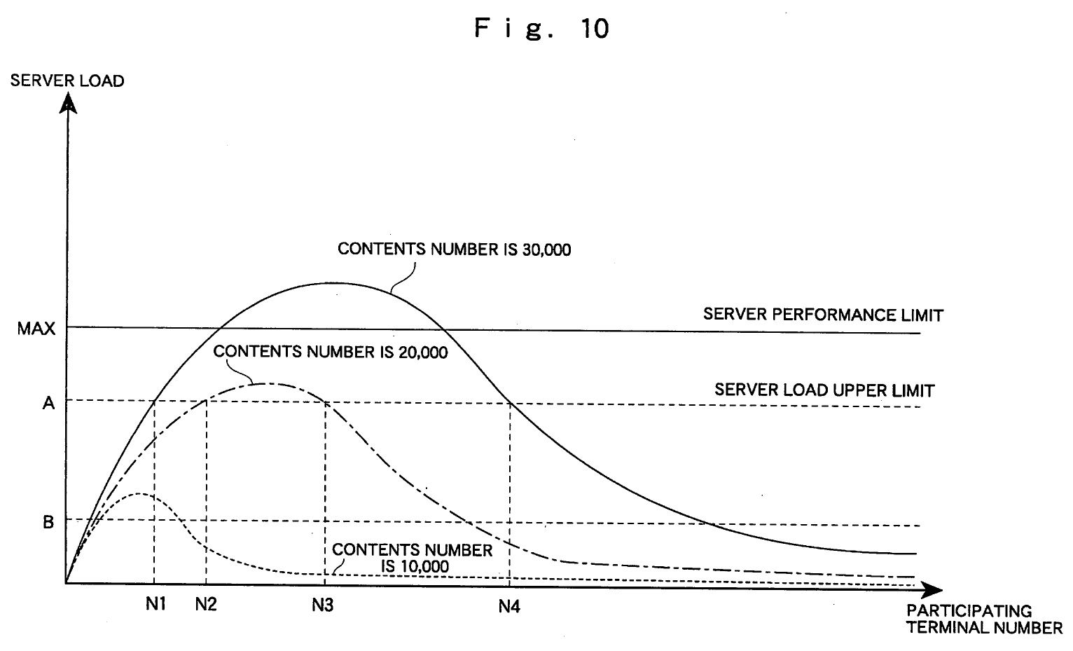

FIG. 10 is a diagram showing an example of the relationship between the heretofore described server load and participating terminal number, graphed for each contents number. As shown in the diagram, the larger the contents number in the contents distribution system S, the more the server load increases. Also, in a condition in which there is no increase or decrease in the contents number in the contents distribution system S, although the server load increases along with the participating terminal number increasing, in the event that the participating terminal number reaches a certain level, with that as a boundary, the server load decreases. A shape of this curve is unique to the P2P type of contents distribution system. As the distribution of contents between the terminal apparatus becomes more flexible the more the participating terminal number increases, accesses to the contents supply apparatus 10 decrease. Conversely, for as long as the participating terminal number is extremely small, as a contents request number itself is small, the accesses to the contents supply apparatus 10 also decrease. When the participating terminal number is of an intermediate value, the number of accesses to the contents supply apparatus 10 becoming comparatively large, this kind of shape occurs. For example, when the contents number in FIG. 10 is 30,000, when the participating terminal number is approximately halfway between N1 and N4, the server load of the contents supply apparatus 10 is at a peak.

In the event that, in this way, the contents number in the contents distribution system S is inappropriate compared with the number of terminal apparatus 1, there is a danger that the server load of the contents supply apparatus 10 exceeds the server performance limit, as shown in FIG. 10. When this kind of condition occurs, it is possible to reduce the server load of the contents supply apparatus 10 by increasing or decreasing a usable contents number in the contents distribution system S (being a number of items of contents data which can be transmitted and received among the terminal apparatus, hereafter also called a “disclosed contents number”).

The server load of the contents supply apparatus 10 is determined by a relationship between a number of contents data transmission requests from the terminal apparatus 1 participating in the contents distribution system S (hereafter taken to be a “contents demand number”) and a transmittable number of items of contents data which can be transmitted by the terminal apparatus 1 participating in the contents distribution system S (hereafter taken to be a “contents supply number”).

Herein, the contents demand number can largely be taken to be obtained by an estimated viewing rate being multiplied by the participating terminal number. Also, the contents supply number can largely be taken to be obtained by a distribution, capability (for example, a calculation capability, a network speed, a contents data storage number, and the like) of each terminal apparatus being multiplied by the participating terminal number.

In this way, the server load of the contents supply apparatus 10 changes depending on the disclosed contents number and the participating terminal number. Consequently, by increasing or decreasing the disclosed contents number in response to a change in the participating terminal number, it is possible to adjust the server load of the contents supply apparatus 10. In the embodiment, it is arranged in such a way that, by changing the disclosed contents number in accordance with the participating terminal number, the contents supply apparatus 10 server load condition does not exceed the server performance limit.

The adjustment by the contents management apparatus 20 is carried out by reducing the disclosed contents number when, due to the relationship between the participating terminal number and the disclosed contents number, the participating terminal number is small, and increasing the disclosed contents number when, due to the relationship between the participating terminal number and the disclosed contents number, the participating terminal number is large.

The reduction of the disclosed contents number by the contents management apparatus 20 is carried out by changing details of the contents list, in which names of contents provided in the contents distribution system S (that is, contents data which can be transmitted and received among the terminal apparatus 1) are listed. For example, when it is taken that there are 10,000 contents data (hereafter taken to be an “all contents number”) existing in the contents distribution system S, it is possible to essentially reduce the disclosed contents number by two fifths by reducing a number of contents data included in the contents list (hereafter taken to be an “included contents number”) by around 4,000.

Also, the increase of the disclosed contents number by the contents management apparatus 20 is carried out by relaxing or removing a limit on the contents data included in the contents list. For example, in a condition in which, when the all contents number is taken to be 10,000, the included contents number is 6,000, it is possible, by increasing the included contents number by around 2,000, to essentially increase the disclosed contents number by one third.

In a condition in which no limit is being imposed on the contents data included in the contents list (that is, when the all contents number equals the included contents number), it is not possible to carry out the increase of the disclosed contents number by the heretofore described method. Therein, with the contents management apparatus 20 in the embodiment, it is arranged in such a way that it is possible to set so as to request the contents supply apparatus 10 to newly introduce a number of contents data corresponding to a necessary increase of the disclosed contents data. In response to the request, the contents supply apparatus 10 introduces the contents data into a plurality of the terminal apparatus 1, in response to which, the contents management apparatus 20 increases the included contents number of the contents list. It is also possible to arrange in such a way as to increase the contents holding terminal apparatus by, instead of newly introducing the contents data, transmitting already introduced contents data to the terminal apparatus.

Meanwhile, it is possible for the contents management apparatus 20 to predict the participating terminal number from a condition of the routing table of the terminal apparatus 1. That is, the participating terminal number is large when there is a large number of items of information on the terminal apparatus 1 included in the routing table, and the participating terminal number is small when there is a small number of items of information on the terminal apparatus 1 included in the routing table. Consequently, the contents management apparatus 20 calculates the participating terminal number by multiplying a predetermined coefficient by the number of items of information (for example, the terminal ID) on the terminal apparatus included in the routing table. It is also acceptable to arrange in such a way that the contents management apparatus 20 causes the routing table of the terminal apparatus 1 to be transmitted from the terminal apparatus 1 at the same time when the terminal apparatus 1 requests the contents list or contents key, or requests a predetermined terminal apparatus 1 to regularly transmit the routing table. Also, it is also acceptable to arrange in such a way that a terminal apparatus 1 which carries out a participation in, or withdrawal from, the contents distribution system S notifies the contents management apparatus 20 of the participation or withdrawal, or that the terminal apparatus 1 participating in the contents distribution system S regularly notify the contents management apparatus 20 that they are participating, and that the contents management apparatus 20 detects the participating terminal number based on these notifications.

Hereafter, a more specific description will be given, referring to the drawings, of a configuration and operations of each apparatus in the contents distribution system S.

1.2. Description of Configuration and the Like of Terminal Apparatus 1

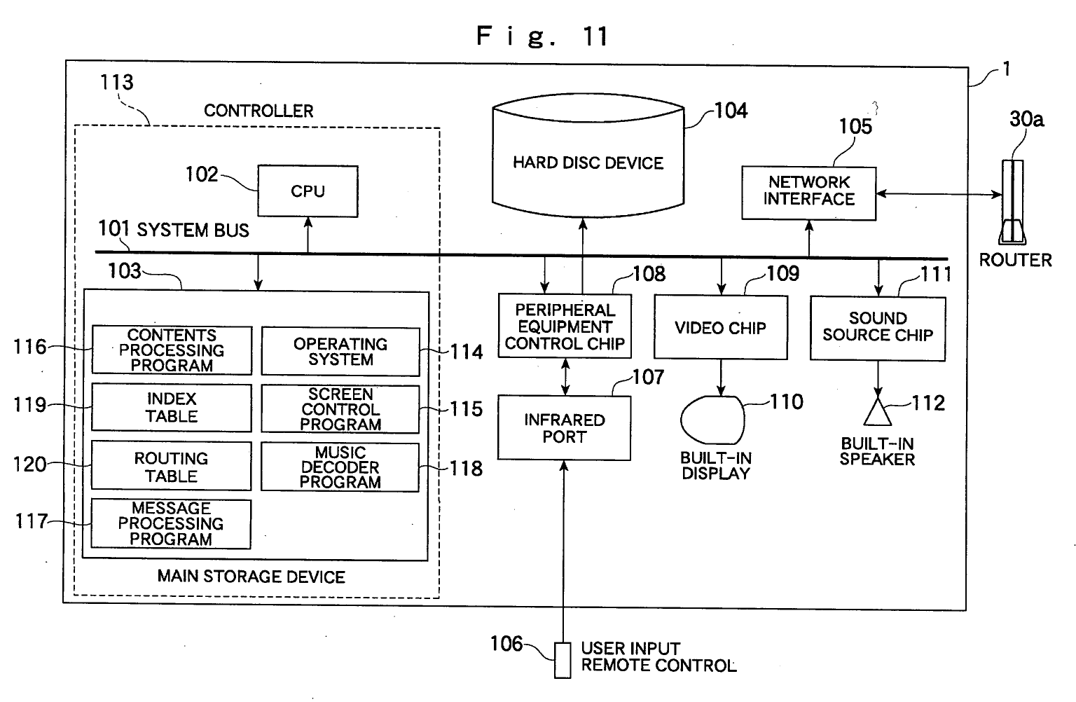

Next, a description will be given of a configuration and operations of the terminal apparatus 1, referring to the drawings. FIG. 11 is a diagram showing an outline configuration of the terminal apparatus 1 in the contents distribution system S according to the embodiment.

The terminal apparatus 1, a general personal computer as well as a designated computer being applicable, being configured, as shown in FIG. 11, including a CPU (Central Processing Unit) 102, a first memory 103, as a rewritable main storage device which stores various kinds of program and the like, a second memory 104, configured of an HDD (Hard Disc Drive) or the like, which stores various kinds of data and the like, a network interface 105, for carrying out communication with other terminal apparatus 1 participating in the network 8 via a router 30a, a remote control 106, which transmits and receives a predetermined infrared signal for a remote operation by a user of the terminal apparatus 1, an infrared port 107 for carrying out communication with the remote control 106 by means of infrared rays, a peripheral equipment control chip 108, which controls the infrared port 107, a video chip 109 which receives image data by a control of the CPU 102, writes them into an internal video memory (not shown), and displays the data written into the video memory on a built-in display 110, to be described hereafter, the built-in display 110, a sound source chip 111 which has a sound source such as an FM sound source or a Wave Table sound source and, by transmitting an audio signal to a built-in speaker 112, outputs a sound wave from the built-in speaker 112, and the built-in speaker 112, these various kinds of component are mutually connected via a system bus 101. In the embodiment, a controller 113 is configured of the CPU 102 and the first memory 103.

First Memory 103

Also, an operating system (OS) program 114 for providing basic functions of the terminal apparatus 1 as a computer, a screen control program 115 for carrying out a control, or the like, of the built-in display 110, a contents processing program 116 for receiving contents data transmitted from another terminal apparatus 1, which functions as a contents holding terminal apparatus, and for distributing contents data stored in the second memory 104 when the terminal apparatus itself functions as the contents holding terminal apparatus, a message processing program 117 for carrying out a transmission and reception of messages with another terminal apparatus, a music decoder program 118 for carrying out a reproduction, and the like, of distributed contents data, and the like being stored in the first memory 103, they are retrieved by the CPU 102, and functions according to the programs are executed by the CPU 102. Also, an index table storage area 119 for storing an index table (refer to FIG. 7), and a routing table storage area 120 for storing a routing table (refer to FIG. 4), are further provided in the first memory 103.

Herein, the OS program 114, by being retrieved and executed by the CPU 102, renders executable functions relating to an input and output of the remote control 106, and the basic functions of the computer, which is the terminal apparatus 1, such as a memory management of the first memory 103, the second memory 104, and the like. Then, in a condition in which the OS program 114 is executed by the CPU 102, the heretofore described screen control program 115, contents processing program 116, message processing program 117, music decoder program 118, and the like, are retrieved from the first memory 103, and executed. Although the programs have been separated here in order to facilitate the description, it is acceptable to make them into one program, and there is, of course, no objection to making them into two programs.

It is also acceptable that the OS program 114, screen control program 115, contents processing program 116, message processing program 117, music decoder program 118, and the like are, for example, downloaded via the network interface 105 into the first memory 103 from a server, or the like, connected to the network 8, and it is also acceptable that, after being recorded on a recording medium such as a CD-ROM, they are loaded into the first memory 103 via an unshown recording medium drive.

Second Memory 104

The second memory 104 has a contents list storage area which stores a contents list, in which names of contents introduced from the contents supply apparatus 10, and provided in the contents distribution system S, are listed, a contents data storage area functioning as a contents data storage unit, which stores contents data distributed from the contents supply apparatus 10, or the like, a contents key storage area functioning as a contents key storage unit, which stores a contents key received from the contents management apparatus 20, and the like.

Controller 113

The controller 113, being configured, as heretofore described, of the CPU 102 and first memory 103, centrally controls a whole of the terminal apparatus 1 by the CPU 102 retrieving and executing the various kinds of program 114 to 118 stored in the first memory 103, as well as functioning as a display control unit, a contents data acquisition request detection unit, a contents data acquisition unit, a contents data transmission unit, a contents key acquisition unit, a decoding unit, a contents data reproduction unit, a message destination determination unit, a message forwarding unit, a registered message transmission unit, a contents holding terminal information acquisition unit, a terminal identification information transmission unit, and the like, to be described hereafter.

The controller 113 functions as the display control unit, by the CPU 102 executing the screen control program 115, also, as the contents data acquisition request detection unit, contents data acquisition unit, contents data transmission unit, contents key acquisition unit, contents data reproduction unit and the like, by the CPU 102 executing the contents processing program 116, also, as the message destination determination unit, message forwarding unit, registered message transmission unit, contents holding terminal information acquisition unit, terminal identification information transmission unit, and the like, by the CPU 102 executing the message processing program 117, also, as the decoding unit, and the like, by the CPU 102 executing the music decoding program 118.

The display control unit, controlling the video chip 109 and built-in display 110, has a function of displaying various kinds of image information (graphical information). That is, the display control unit controls in what way an image is displayed on the built-in display 110.

The contents data acquisition request detection unit detects a contents data acquisition request operation by the user. For example, when a contents list which the terminal apparatus 1 has acquired from the contents management apparatus 20 is displayed by the display control unit on the built-in display 110, by the user of the terminal apparatus 1 operating the remote control 106, the contents data acquisition request operation is performed by the user selecting a desired contents name, and the operation is detected by the contents data acquisition request detection unit.

Information for identifying contents data, such as names of contents distributable in the contents distribution system S, being included in the contents list, the display control unit displays a list of the contents names included in the contents list on the built-in display 110. By the contents data acquisition request detection unit making a regular request to the contents management apparatus 20, the terminal apparatus 1 acquires and displays a latest contents list.

When the acquisition request operation is detected by the contents data acquisition request detection unit, the contents key acquisition unit requests of the contents management apparatus 20, via the network, a transmission of a contents data contents key corresponding to the acquisition request operation. Also, the contents key acquisition unit receives the contents key transmitted from the contents management apparatus 20 in response to the request, and stores it in the contents key storage area of the second memory 104. The request from the contents key acquisition unit for the transmission of the contents key is carried out specifying a contents name, contents ID, or the like, of the contents data corresponding to the contents key.

When a message received via the network interface 105 is a contents data holding request from the contents supply apparatus 10, the contents data acquisition unit acquires the contents data from the contents supply apparatus 10. Then, the contents data acquisition unit stores the acquired contents data in the second memory 104, which acts as the contents data storage unit.

Also, on the contents key being acquired by the contents key acquisition unit when the acquisition request operation by the user is detected by the contents data acquisition request detection unit, the contents data acquisition unit acquires the contents data corresponding to the acquisition request operation from another terminal apparatus 1, via the network 8.

Herein, when acquiring the contents data from another terminal apparatus 1, the contents data acquisition unit generates a search message for searching for an IP address, which is location information of a contents holding terminal apparatus which is holding the contents data it is attempting to acquire. The search message is a message which makes a contents ID, which is identification information of the requested contents data, destination identification information, and makes a terminal ID, which is identification information of the terminal apparatus itself, request source identification information. The contents data acquisition unit retrieves, from the contents list, the contents name of the contents data it is trying to acquire, and determines the contents ID by hashing the retrieved contents name with the same hash function as when acquiring the terminal ID. It is also acceptable to include in advance contents ID corresponding to the contents data in the contents list in the contents management apparatus 20.

The contents data acquisition unit, selecting a transmission destination terminal apparatus which satisfies a predetermined condition, based on the contents ID which is the destination identification information of the generated search message, transmits the search message. Herein, the “predetermined condition” is a condition by which the contents data acquisition unit selects a terminal ID, among the terminal ID stored in the routing table, of which the most leading digits match the contents ID, which is the destination identification information of the search message.

The contents data acquisition unit receives the IP address, which is the location information of the contents holding terminal apparatus transmitted from the root terminal apparatus in response to the transmitted search message and, based on this information, makes a request to the contents holding terminal apparatus for the contents data corresponding to the acquisition request operation. In response to the request, the contents data are distributed streamed from the contents holding terminal apparatus. The contents data acquisition unit sequentially receives the contents data distributed streamed, and stores them in the second memory 104.

Also, when the contents data corresponding to the acquisition request operation by the user cannot be acquired from the request terminal apparatus, the contents data acquisition unit acquires the contents data corresponding to the acquisition request operation from the contents supply apparatus 10.

The contents data reproduction unit, when acquiring the contents data corresponding to the acquisition request operation from the contents holding terminal apparatus, after decoding the contents data distributed streamed from the contents holding terminal apparatus with the contents key stored in the contents key storage area of the second memory 104, decodes them with the decoding unit, and reproduces the contents data by operating the video chip 109 and sound source chip 111.

Also, when reproducing the contents data stored in the second memory 104 too, the contents data reproduction unit, in the same way, after decoding the contents data with the contents key stored in the contents key storage area of the second memory 104, decodes them with the decoding unit, and reproduces them.

When there has been a request from another terminal apparatus 1 for a transmission of the contents data stored in the second memory 104, which acts as the contents data storage unit, the contents data transmission unit retrieves the contents data corresponding to the transmission request from the second memory 104, and transmits them to the other terminal apparatus 1 which has made the transmission request.

The decoding unit decodes the contents data stored in the second memory 104, or the contents data transmitted streamed from the contents holding terminal apparatus, in order to display them on the built-in display 110, and output them from the built-in speaker 112. That is, the contents data which are a subject of reproduction being encoded by a predetermined format, the contents data encoded in this way are decoded in order that they can be displayed on the built-in display 110, and output from the built-in speaker 112.

The message destination determination unit, based on the destination identification information and routing table of the message received via the network 8, determines whether or not the received message is addressed to its own terminal apparatus. A message determined by the message destination determination unit is a search message, for requesting identification information of a contents holding terminal apparatus from a root terminal apparatus, a registration message, for registering identification information of a contents holding terminal apparatus in a root terminal apparatus, or the like.

The determination of whether or not the received message is addressed to its own terminal apparatus is carried out by retrieving the destination identification information included in the message, and is based on the routing table stored in the first memory 103. That is, when receiving the various kinds of message via the network interface 105, the message destination determination unit compares the destination identification information included in the received message with the terminal ID stored in the routing table and, in the event that it determines that the terminal ID in the routing table which is nearest the destination identification information included in the message is the terminal ID of its own terminal apparatus, determines that it is a message addressed to its own terminal apparatus.

In the event that it is determined, by the message destination determination unit, that the message received via the network 8 is not addressed to its own terminal apparatus, the message forwarding unit, based on the destination identification information of the received message, selects a transmission destination terminal apparatus from the identification information of the terminal apparatus 1 stored in the routing table, and forwards the received message to the transmission destination terminal apparatus. That is, the message forwarding unit selects a terminal ID, among the terminal ID of the terminal apparatus 1 stored in the routing table, which is near the destination identification information and, thereby knowing the IP address of the terminal apparatus 1 corresponding to the selected terminal ID, makes the IP address a destination of an IP packet, and forwards the message.

The registered message transmission unit, when storing the contents data received from the contents supply apparatus 10 in the second memory 104, which is the contents data storage unit, makes the contents ID, which is the identification information of the contents data, the destination identification information, generates a registration message including the terminal ID and IP address, which are the identification information of its own terminal apparatus, and transmits it to the transmission destination terminal apparatus selected based on the routing table. Also, when receiving the contents data from another contents holding terminal apparatus too, in the same way, the registered message transmission unit stores the received contents data in the second memory 104, which is the contents data storage unit, generates a registration message, and transmits it to the transmission destination terminal apparatus selected based on the routing table.

The contents holding terminal information acquisition unit, when the received message is a registration message addressed to its own terminal apparatus, acquires the terminal ID, IP address, and the like, which are the identification information of the contents holding terminal apparatus included in the registration message, for its own terminal apparatus. Then, it stores the index information acquired in this way in the index table.

In the event that the terminal ID of the contents holding terminal apparatus corresponding to the contents requested by the search message is stored, the terminal identification information transmission unit transmits the IP address, which is the location information of the contents holding terminal apparatus, toward the request terminal apparatus which has transmitted the search message.

### 1.3. Description of Configuration and the Like of Contents Supply Apparatus 10

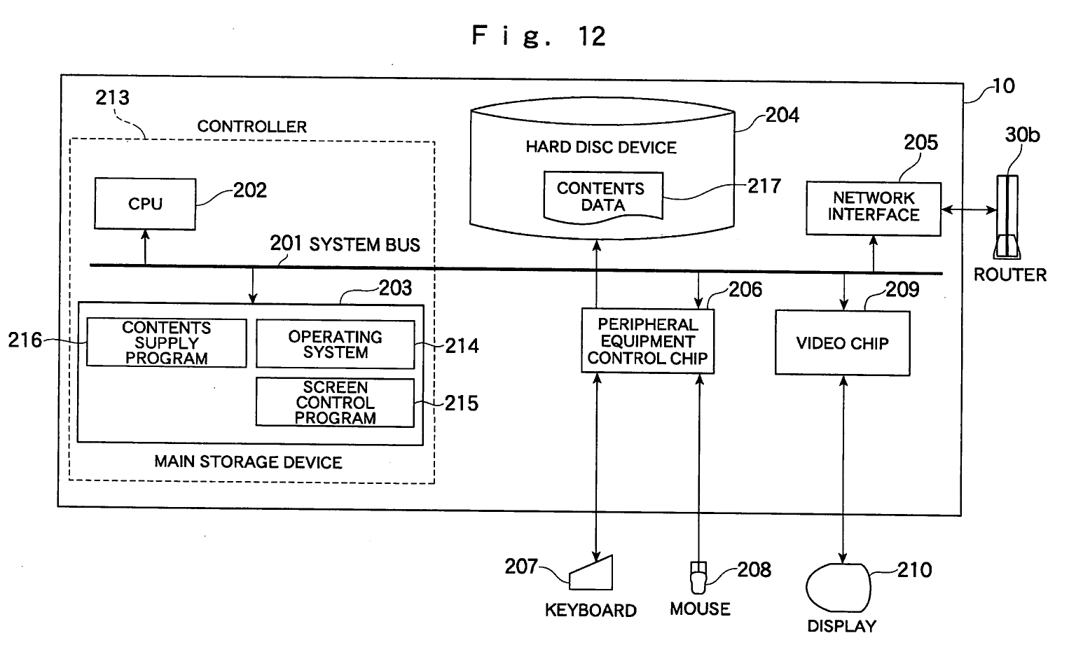

Next, a description will be given of a configuration and operations of the contents supply apparatus 10, referring to the drawings. FIG. 12 is a diagram showing an outline configuration of the contents supply apparatus 10 in the contents distribution system S according to the embodiment.

The contents supply apparatus 10, a general server computer as well as a designated computer being applicable, being configured, as shown in FIG. 12, including a CPU (Central Processing Unit) 202, a first memory 203, as a rewritable main storage device which stores various kinds of program and the like, a second memory 204, configured of an HDD or the like, which stores various kinds of data and the like, a network interface 205, for carrying out communication with other terminal apparatus 1 participating in the network 8, and with the contents management apparatus 20, via a router 30b, a keyboard 207 and a mouse 208, which are an input unit for inputting information for carrying out a control of the contents supply apparatus 10 by a manager of the contents distribution system S, a peripheral equipment control chip 206 for processing the information input from the input unit, a video chip 209 which receives image data by a control of the CPU 202, writes them into an internal video memory (not shown), and displays the data written into the video memory on a display 210, to be described hereafter, the display 210, and the like, these various kinds of component are mutually connected via a system bus 201. In the embodiment, a controller 213 is configured of the CPU 202 and the first memory 203.

First Memory 203

Also, an operating system (OS) program 214 for providing basic functions of the contents supply apparatus 10 as a computer, a screen control program 215 for carrying out a control, or the like, of the display 210, a contents supply program 216 for newly introducing contents data into the contents distribution system S, and transmitting the contents data in response to a request from the terminal apparatus 1, and the like being stored in the first memory 203, they are retrieved by the CPU 202, and functions according to the programs are executed by the CPU 202.

Herein, the OS program 214, by being retrieved and executed by the CPU 202, renders executable functions relating to the keyboard 207 and the mouse 208, and the basic functions of the computer, which is the contents supply apparatus 10, such as a memory management of the first memory 203, the second memory 204, and the like. Then, in a condition in which the OS program 214 is executed by the CPU 202, the heretofore described screen control program 215, contents supply program 216, and the like, are retrieved from the first memory 203, and executed. Although the programs have been separated here in order to facilitate the description, it is acceptable to make them into one program, and there is, of course, no objection to making them into two programs.

Second Memory 204

The second memory 204 has a contents data storage area 217 which stores contents data being provided, and contents data due to be provided, in the contents distribution system S.

Controller 213

The controller 213, being configured, as heretofore described, of the CPU 202 and first memory 203, centrally controls a whole of the contents supply apparatus 10 by the CPU 202 retrieving and executing the various kinds of program 214 to 216 stored in the first memory 203, as well as functioning as a display control unit, a contents introduction unit, a contents transmission unit, and the like, to be described hereafter.

The controller 213 functions as the display control unit and the like, by the CPU 202 executing the screen control program 215, also, as the contents introduction unit, contents transmission unit and the like, by the CPU 202 executing the contents supply program 216.

The display control unit, controlling the video chip 209 and display 210, has a function of displaying various kinds of image information (graphical information). That is, the display control unit controls in what way an image is displayed on the display 210.

The contents introduction unit randomly determines a terminal apparatus 1 to be caused to hold the contents data stored in the contents data storage area 217, that is, a contents holding terminal apparatus, and transmits the contents data to the determined contents holding terminal apparatus. It is acceptable that a number of contents holding terminal apparatus which the contents introduction unit randomly determined is, for example, one, as heretofore described or, in the event that it is possible to predict the popularity of the contents to be introduced, it is possible, as heretofore described, to increase or decrease depending on the predicted popularity.

The contents transmission unit, in the event that there is a request for a transmission of contents data from a terminal apparatus 1 via the network, retrieves contents data corresponding to the transmission request from the second memory 204, which is a contents storage unit, and transmits them to the terminal apparatus 1 which is the request source.

### 1.4. Description of Configuration and the Like of Contents Management Apparatus 20

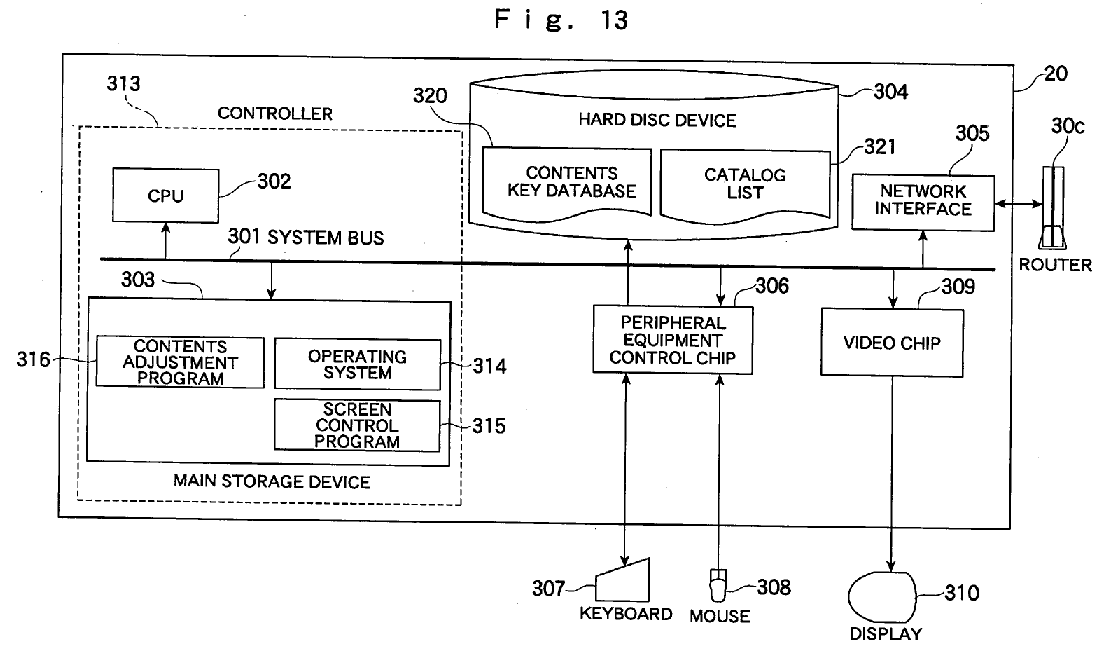

Next, a description will be given of a configuration and operations of the contents management apparatus 20, referring to the drawings. FIG. 13 is a diagram showing an outline configuration of the contents management apparatus 20 in the contents distribution system S according to the embodiment.

The contents management apparatus 20, a general server computer as well as a designated computer being applicable, being configured, as shown in FIG. 13, including a CPU (Central Processing Unit) 302, a first memory 303, as a rewritable main storage device which stores various kinds of program and the like, a second memory 304, configured of an HDD or the like, which stores various kinds of data and the like, a network interface 305, for carrying out communication with other terminal apparatus 1 participating in the network 8 via a router 30c, a keyboard 307 and a mouse 308, which are an input unit for inputting information for carrying out a control of the contents management apparatus 20 by the manager of the contents distribution system S, a peripheral equipment control chip 306 for processing the information input from the input unit, a video chip 309 which receives image data by a control of the CPU 302, writes them into an internal video memory (not shown), and displays the data written into the video memory on a display 310, to be described hereafter, the display 310, and the like, these various kinds of component are mutually connected via a system bus 301. In the embodiment, a controller 313 is configured of the CPU 302 and the first memory 303.

First Memory 303

Also, an operating system (OS) program 314 for providing basic functions of the contents management apparatus 20 as a computer, a screen control program 315 for carrying out a control, or the like, of the display 310, a contents adjustment program 316 for changing the number of contents data which can be transmitted and received among the terminal apparatus 1, based on the contents supply apparatus 10 server load condition, and the like being stored in the first memory 303, they are retrieved by the CPU 302, and functions according to the programs are executed by the CPU 302.

Herein, the OS program 314, by being retrieved and executed by the CPU 302, renders executable functions relating to the keyboard 307 and the mouse 308, and the basic functions of the computer, which is the contents management apparatus 20, such as a memory management of the first memory 303, the second memory 304, and the like. Then, in a condition in which the OS program 314 is executed by the CPU 302, the heretofore described screen control program 315, contents adjustment program 316, and the like, are retrieved from the first memory 303, and executed. Although the programs have been separated here in order to facilitate the description, it is acceptable to make them into one program, and there is, of course, no objection to making them into two programs.

It is also acceptable that the OS program 314, screen control program 315, contents adjustment program 316, and the like are, for example, downloaded via the network interface 305 into the first memory 303 from a server, or the like, connected to the network 8, and it is also acceptable that, after being recorded on a recording medium such as a CD-ROM, they are loaded into the first memory 303 via an unshown recording medium drive.

Second Memory 304

The second memory 304 has a contents key database area 320 which acts as a contents key storage unit in which are stored contents keys, for decoding contents data introduced from the contents supply apparatus 10 and provided in the contents distribution system S, correlated to a contents ID of each item of contents data, and a contents list storage area 321 which acts as a contents list storage unit which stores a contents list, in which names of the contents data provided in the contents distribution system S are listed.

Controller 313

The controller 313, being configured, as heretofore described, of the CPU 302 and first memory 303, centrally controls a whole of the contents management apparatus 20 by the CPU 302 retrieving and executing the various kinds of program 314 to 316 stored in the first memory 303, as well as functioning as a display control unit, a terminal apparatus number detection unit, a contents number determination unit, a contents number adjustment unit, a contents list provision unit, a key information provision unit, and the like, to be described hereafter.

The controller 313 functions as the display control unit, by the CPU 302 executing the screen control program 315, also, as the terminal apparatus number detection unit, contents number determination unit, contents number adjustment unit, contents list provision unit, key information provision unit and the like, by the CPU 302 executing the contents adjustment program 316.

The display control unit, controlling the video chip 309 and display 310, has a function of displaying various kinds of image information (graphical information). That is, the display control unit controls in what way an image is displayed on the display 310.

The terminal apparatus number detection unit detects the number of terminal apparatus 1 (the participating terminal number) configuring the contents distribution system S at a predetermined interval (for example, every three minutes).

The detection of the participating terminal number by the terminal apparatus number detection unit is carried out by estimating from a condition of the routing table of the terminal apparatus 1. That is, the terminal apparatus number detection unit calculates the participating terminal number by multiplying a predetermined coefficient by a number of items of terminal apparatus information (terminal ID etc.) included in the routing table. By calculating using routing tables of a plurality of terminal apparatus, of which positions in the ID space differ widely, it is possible to accurately detect the participating terminal number, even when there is a bias of the terminal ID in the ID space.

The routing table is acquired by causing it to be transmitted from the terminal apparatus 1 at the same time when the terminal apparatus 1 requests a contents list or contents key, or by requesting a predetermined terminal apparatus 1 to regularly transmit the routing table.

Also, it is also acceptable to arrange in such a way as to detect the participating terminal number in accordance with a contents list distribution condition, rather than from the condition of the routing table. The contents list being regularly acquired from the contents management apparatus 20 by the terminal apparatus 1 participating in the contents distribution system S, the terminal apparatus number detection unit calculates an estimated value of the participating terminal number depending on how many terminal apparatus 1 have requested the contents list within a predetermined period, and detects the value as the participating terminal number. For example, in a case in which it is set in such a way that each terminal apparatus 1 acquires the contents list from the contents management apparatus 20 every one hour, when there have been 2,000 requests for the transmission of the contents list within ten minutes, the terminal apparatus number detection unit calculates 2,000×6, and detects 12,000, which is a result of the calculation, as the participating terminal number.

Also, it is also acceptable to calculate the estimated value of the participating terminal number based on a number of requests for a contents key, and on a time period, rather than on the number of requests for the contents list or the condition of the routing table, and detect the value as the participating terminal number. For example, it is estimated that a contents key request rate per 10,000 participating terminals is 500 in a time period of eight a.m. to ten a.m., and 700 in a time period of eight p.m. to ten p.m., and a setting is done. Then, when there have been 200 contents key requests in the time period of eight a.m. to ten a.m., the terminal apparatus number detection unit calculates 10,000×200/500, and detects 4,000, which is a result of the calculation, as the participating terminal number.

Also, it is also acceptable to calculate the estimated value of the participating terminal number based on a number of all the qualified terminal apparatus participating in the contents distribution system S, and on a time period, rather than on the condition of the routing table, or the number of requests for the contents list or contents key, and detect the value as the participating terminal number. For example, taking the number of all the terminal apparatus qualified to participate in the contents distribution system S to be 100,000, estimating a participation rate in the time period of eight a.m. to ten a.m. to be 15%, and a participation rate in the time period eight p.m. to ten p.m. to be 25%, and setting, the terminal apparatus number detection unit, for the time period of eight a.m. to ten a.m., calculates 100,000×0.15, and detects 15,000, which is a result of the calculation, as the participating terminal number. The number of the terminal apparatus qualified to participate in the contents distribution system S is set in the first memory 303 by the manager, or the like, of the contents distribution system S inputting it, using an input unit such as the keyboard 307 or mouse 308.

Also, as a method other than the ones heretofore described, it is also acceptable to arrange in such a way that the terminal apparatus 1 participating in the contents distribution system S are caused to regularly transmit information, to the effect that they are participating, to the contents management apparatus 20, and that the terminal apparatus number detection unit detects the participating terminal number based on the information transmitted in this way.

The contents number determination unit, based on the participation terminal number detected by the terminal apparatus number detection unit, determines an appropriate number of contents data (hereafter also called an “appropriate contents number”) which can be transmitted and received among the terminal apparatus 1.

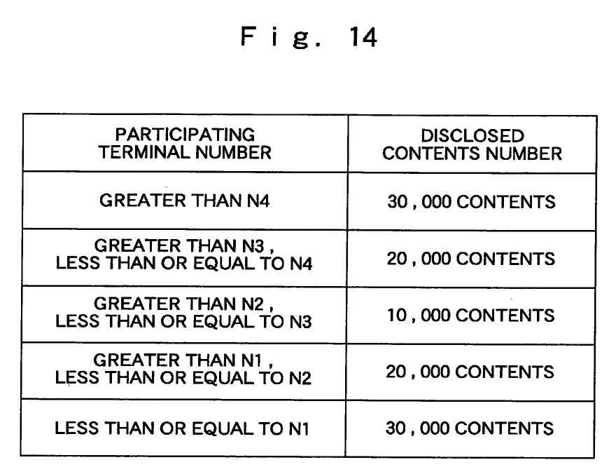

For example, when the contents distribution system S has the characteristics shown in FIG. 10, the contents number determination unit determines the appropriate contents number based on the kind of table shown in FIG. 14. That is, the contents management apparatus 20, referring to the table, determines the appropriate contents number as 30,000 when the participating terminal number is less than or equal to N1, or when N4 is less than the participating terminal number, determines the appropriate contents number as 20,000 when N1 is less than the participating terminal number, which is less than or equal to N2, or when N3 is less than the participating terminal number, which is less than or equal to N4, and determines the appropriate contents number as 10,000 when N2 is less than the participating terminal number, which is less than or equal to N3.

Also, it is also acceptable to arrange in such a way that, setting a contents data transmission and reception rate predicted for each unit time in the first memory 303, which is the storage unit, the contents number determination unit, based on the participating terminal number detected by the terminal apparatus number detection unit, and on the transmission and reception rate set in the first memory 303, determines the appropriate contents number. Herein, the contents data transmission and reception rate is set in the first memory 303 by the manager, or the like, of the contents distribution system S inputting it, using an input unit such as the keyboard 307 or mouse 308.

The contents number adjustment unit changes the number of contents data (the disclosed contents number) which can be transmitted and received among the terminal apparatus 1, depending on the number of contents data (the appropriate contents number) determined by the contents number determination unit.

In the event that the contents number adjustment unit determines that the number of contents data which can be transmitted and received among the terminal apparatus of the contents distribution system S at the present moment (hereafter, also called a “present contents number”) is a predetermined number or more greater than the appropriate contents number, it reduces the disclosed contents number by a predetermined number. For example, when the contents distribution system S has the kind of characteristics shown in FIG. 10, when the present contents number is 25,000 and N1 is less than the participating terminal number, which is less than or equal to N2, the contents number adjustment unit reduces the disclosed contents number by about 5,000. Herein, although the “present contents number” is obtained by the contents number adjustment unit calculating from the number, timing and viewing rate (the estimated value of the transmission and reception rate of the contents data) of all the contents data introduced into the contents distribution system S by the contents supply apparatus 10, it is also acceptable to calculate using another parameter. Also, it is also acceptable to arrange in such a way that the terminal apparatus 1 holding the contents data is caused to regularly report on details held, and the contents number adjustment unit gathers the details, and calculates them as the present contents number.

Also, in the event that the contents number adjustment unit determines that the present contents number is a predetermined number or more smaller than the appropriate contents number, it increases the disclosed contents number by a predetermined number. For example, when the contents distribution system S has the kind of characteristics shown in FIG. 10, when the present contents number is 18,000 and N1 is less than the participating terminal number, which is less than or equal to N2, the contents number adjustment unit increases the disclosed contents number by about 2,000.

Herein, a function as a contents list generation unit being included in the contents number adjustment unit, the adjustment of the disclosed contents number by the contents number adjustment unit is carried out by changing the list details of the contents list.

The contents list generation unit increases or decreases the disclosed contents number, based on the present contents number and the appropriate contents number. Specifically, when the present contents number is a predetermined number or more greater than the appropriate contents number, the contents list generation unit carries out an update of the contents list by generating a contents list in which the included contents number has been reduced by a predetermined rate. Also, when the present contents number is a predetermined number or more smaller than the appropriate contents number, the contents list generation unit carries out an update of the contents list by generating a contents list in which the included contents number has been increased by a predetermined rate. Conversely, when the present contents number is within a predetermined range of the appropriate contents number, the contents list generation unit does not carry out an update of the contents list.

In this way, the contents management apparatus 20 in the embodiment, based on the present contents number and the appropriate contents number, increases or decreases the contents data number (the disclosed contents number) which can be transmitted and received among the terminal apparatus in every predetermined period. Consequently, it is possible to take measures in advance against problems such as the contents supply apparatus 10 crashing due to overloading. In particular, as the increasing or decreasing of the disclosed contents number is carried out by increasing or decreasing the number of contents data included in the contents list, it does not happen that the process becomes complicated. Also, as heretofore described, as a table to which the participating terminal number and the appropriate contents number are correlated is stored in the second memory 304, and the disclosed contents number is changed based on this table, it is possible to carry out the change of the disclosed contents number easily.

Herein, it is preferable that the predetermined number by which the disclosed contents number is increased, and the predetermined number by which the disclosed contents number is decreased, are different numbers. That is, in the event that the present contents number exceeds an upper limit value, which is considerably larger than the appropriate contents number, as well as, it being an emergency situation, stopping the disclosure in order that a large number of contents data are not transmitted and received, it is possible to effectively deal with the server load by doing a fine adjustment of the server load, carrying out, little by little, a so-called re-disclosure which increases the disclosed contents number.

It is also acceptable to attach an order of priority to contents to be deleted from the contents list, such as, for example, an order of contents age or an order of contents unpopularity.

Also, the contents list generation unit updates the contents list stored in the second memory 304 every time contents data are newly introduced into the contents distribution system S by the contents supply apparatus 10. The update of the contents list is carried out by adding information for identifying contents data, such as a name of the newly introduced contents, to the contents list.

Also, in the description heretofore, it is arranged in such a way that the contents number adjustment unit determines a number by which to increase or reduce the disclosed contents number by comparing the present contents number and the appropriate contents number, but it is also acceptable that, in accordance with a change in the participating terminal number every predetermined period, the contents number determination unit determines a number by which to increase or reduce the disclosed contents number every predetermined period (for example, reducing the disclosed contents number by 1% when the participating terminal number increases by 1%) and, depending on the increase or reduction number, the contents number adjustment unit increases or reduces the disclosed contents number. By so doing, it is possible to contain the contents supply apparatus 10 server load condition within a certain range.

The contents list provision unit, in response to a contents list distribution request from the terminal apparatus 1, retrieves the contents list stored in the second memory 304, and distributes it to the terminal apparatus 1 which has made the distribution request.

The key information provision unit, in the event that there is a request for a contents key from the terminal apparatus 1, retrieves the contents key corresponding to the request from the second memory 304, and transmits it to the terminal apparatus 1 which is the request source. The name, contents ID, and the like, of the contents corresponding to the request being included in the request from the terminal apparatus 1 for the contents key, the key information provision unit retrieves the contents key corresponding to the name and contents ID of the contents from the contents key database of the second memory 304, and transmits it to the terminal apparatus 1 which is the request source.

### 1.5. Operations of Contents Distribution System S

Hereafter, a more specific description will be given, using flowcharts, of detailed operations of the terminal apparatus 1 the contents supply apparatus 10 and contents management apparatus 20.

Description of Terminal Apparatus 1 Process Flow

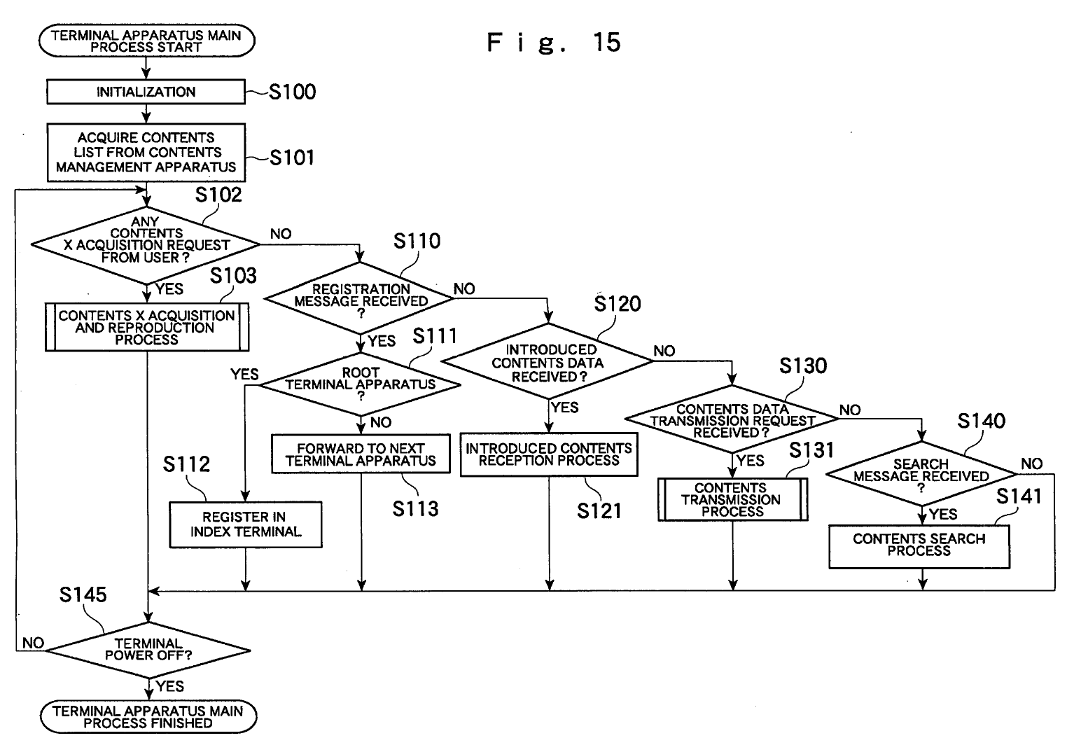

Firstly, a description will be given, referring to the flowcharts of FIGS. 15 to 17, of an example of a more specific operation of the terminal apparatus 1. FIGS. 15 to 17 are flowcharts showing processes in the terminal apparatus 1. Each of the following processes is executed by the controller 113 of the terminal apparatus 1 functioning as the heretofore described units, and the like.

As shown in FIG. 15, on power of the terminal apparatus 1 being turned on, the CPU 102 of the terminal apparatus 1 executes initial setting operations, such as permitting an access to the first memory 103 and second memory 104, and initializing a securing of a working area, puts each program 115 to 118 into a condition in which it is executed by the CPU 102 and, after starting up a function as the controller 113 (step S100), moves the process to step S101.

In step S101, the controller 113 acquires a contents list from the contents management apparatus 20. The acquisition of the contents list is carried out by the controller 113 requesting the contents list from the contents management apparatus 20, and receiving the contents list transmitted in response to the request. Also, the controller 113 thereafter regularly acquires a contents list from the contents management apparatus 20. When acquiring the contents list, the controller 113 transmits the routing table of its own terminal apparatus to the contents management apparatus 20.

Names and the like of a plurality of contents data which can be acquired, as heretofore described, in the contents distribution system S are included in the contents list. The controller 113 acquires the contents list from the contents management apparatus 20, and displays details of the contents list on the built-in display 110. The user of the terminal apparatus 1 can select contents data being provided in the contents distribution system S by carrying out an operation of the remote control 106, or the like, while looking at the details of the contents list displayed on the built-in display 110. Then, when the contents data are selected by the user, by the operation of the remote control 106, or the like, the controller 113 determines that there has been a contents acquisition request operation by the user.

In step S102, the controller 113 determines whether or not there has been an acquisition request operation by the user for certain contents (herein, taken to be the contents X).

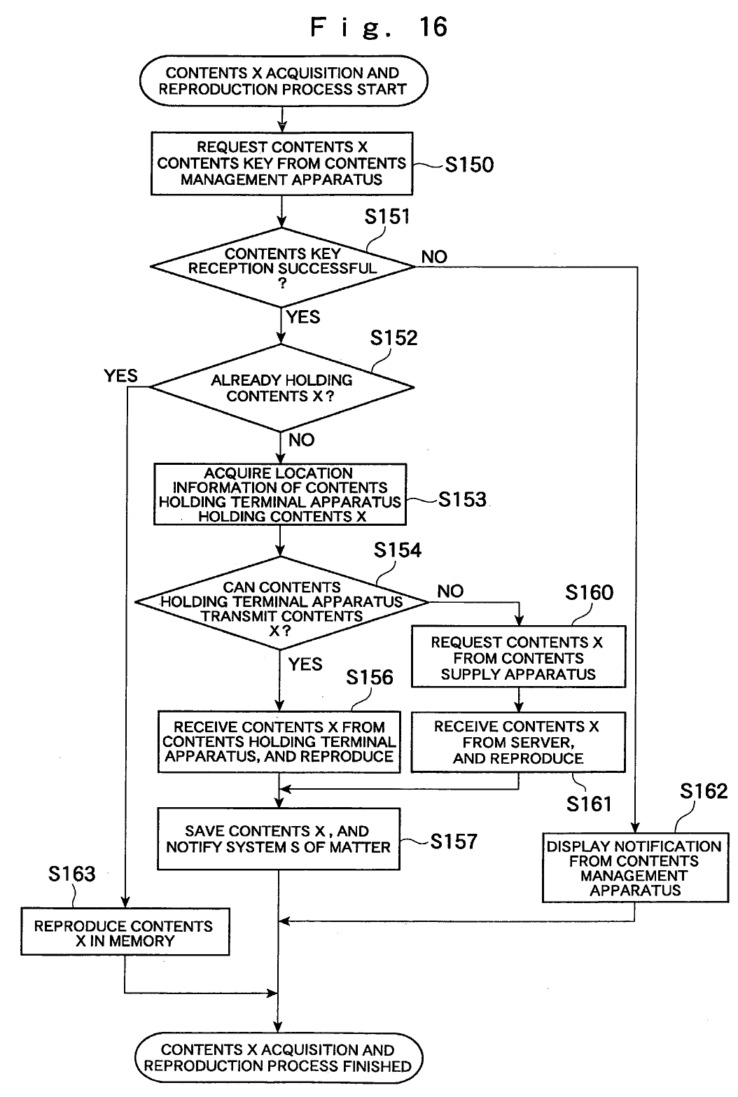

In the process, if it is determined that there has been an acquisition request operation by the user for the contents X (step S102: Yes), the controller 113 shifts to a contents X acquisition and reproduction process (step S103). The process of step S103, being processes S150 to S154, S156, S157, and S160 to S163 in FIG. 16, will be described in detail hereafter.

Conversely, if it is determined, in step S102, that there has been no acquisition request operation by the user for the contents X (step S102: No), the controller 113 determines whether or not a registration message has been received (step S110). Whether or not a registration message has been received is determined by whether or not a registration message transmitted from a contents holding terminal apparatus, via the network 8, has been received by its own terminal apparatus.

In the process, if it is determined that a registration message has been received (step S110: Yes), the controller 113 determines whether or not its own terminal apparatus is the root terminal apparatus (step S111). Whether or not the terminal apparatus 1 is the root terminal apparatus is determined based on the destination identification information of the received registration message, and on the routing table stored in the first memory 103.

In the process, if it is determined that its own terminal apparatus is the root terminal apparatus (step S111: Yes), the controller 113 correlates the IP address of the contents holding terminal apparatus included in the received registration message, and the contents ID, and the like, of the contents data held by the contents holding terminal apparatus, and adds them to the index table of the first memory 103 (step S112). Conversely, if it is determined that the terminal apparatus is not the root terminal apparatus (step S111: No), the controller 113, based on the routing table stored in the first memory 103, forwards the registration message to another terminal apparatus 1 (step S113).

If it is determined, in step S110, that no registration message has been received (step S110: No), the controller 113 determines whether or not contents data introduced from the contents supply apparatus 10 have been received (step S120).

In the process, if it is determined that contents data introduced from the contents supply apparatus 10 have been received (step S120: Yes), the controller 113 carries out a introduced contents reception process (step S121). The introduced contents reception process, as well as saving the contents data introduced from the contents supply apparatus 10 by storing them in the second memory 104, registers them in the index table of the root terminal apparatus. That is, the controller 113 stores the introduced contents data received in step S120 in the contents data storage area of the second memory 104, and saves them. Also, when it is determined that its own terminal apparatus is not the root terminal, the controller 113, based on the routing table, transmits the registration message to another terminal apparatus 1 via the network 8, while when it is determined that its own terminal apparatus is the root terminal, the controller 113 adds the contents ID and the IP address of its own terminal apparatus to the index table, and registers them.

If it is determined, in step S120, that the introduced contents data have not been received (step S120: No), the controller 113 determines whether or not there is a contents data transmission request from another terminal apparatus 1 (step S130).

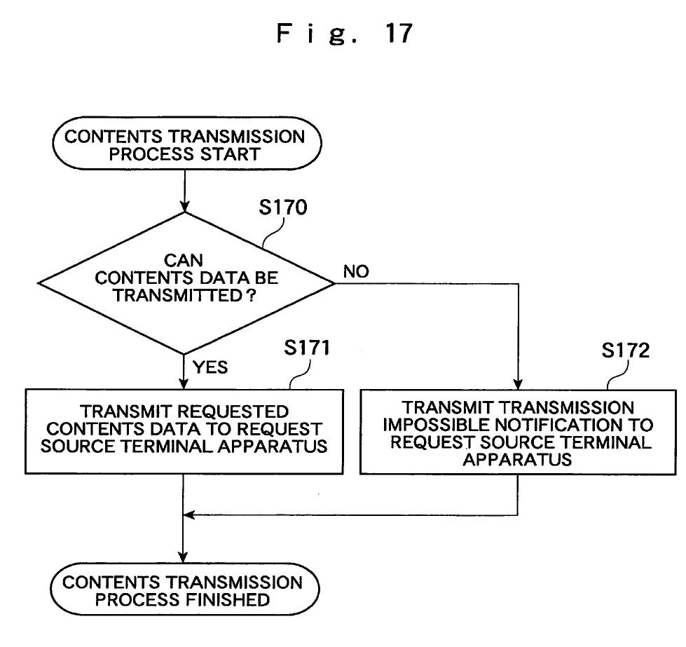

In the process, if it is determined that there has been a contents data transmission request from another terminal apparatus 1 (step S130: Yes), the controller 113 shifts to a contents transmission process of step S131. The contents transmission process of step S131, being processes of S170 to S172 in FIG. 17, will be described in detail hereafter.

Also, if it is determined, in step S130, that there has been no contents data transmission request from another terminal apparatus 1 (step S130: No), the controller 113 determines whether or not a search message has been received (step S140). Whether or not a search message has been received is determined by whether or not a search message transmitted from the request terminal apparatus, via the network 8, has been received.

In the process, if it is determined that a search message has been received (step S140: Yes), the controller 113 carries out a contents search process in step S141. In the contents search process, firstly, the controller 113 acquires the contents ID from the search message received in step S140 and, when its own terminal apparatus 1 is the root terminal apparatus of the contents data with the contents ID, determines whether or not the contents ID exist in the index table. Then, if it is determined that the contents ID acquired from the search message exist in the index table, the controller 113 acquires the IP address, which is the location information, of the contents holding terminal apparatus from the index table, and transmits the IP address of the contents holding terminal apparatus to the request terminal apparatus, via the network 8. Conversely, when its own terminal apparatus 1 is not the root terminal apparatus of the contents data with the contents ID, the controller 113, based on the routing table, forwards the search message to another terminal apparatus.

If it is determined, in step S140, that no search message has been received (step S140: No), when the processes of step S103, step S112, step S113, step S121, step S131 and step S141 are finished, the controller 113 determines whether or not the power of its own terminal apparatus has shifted to an off condition (step S145).

If it is determined, in step S145, that the power of its own terminal apparatus has shifted to the off condition (step S145: Yes), the controller 113 finishes the main process, while if it is determined that the power of its own terminal apparatus has not shifted to the off condition (step S145: No), the controller 113 repeats the process from step S102.

Next, a specific description will be given, referring to the flowchart of FIG. 16, of the contents X acquisition and reproduction process in S103.

As shown in FIG. 16, on the contents X acquisition and reproduction process being started, the controller 113 requests the contents key of the contents X corresponding to the user's acquisition request operation from the contents management apparatus 20, via the network 8 (step S150), and shifts the process to step S151.

In step S151, the controller 113 determines whether or not the reception of the contents X contents key has been successful. The determination of whether or not the reception of the contents key has been successful is made depending on whether or not the controller 113 has been able to receive the contents X contents key from the contents management apparatus 20.

If it is determined, in step S151, that the reception of the contents X contents key has been successful (step S151: Yes), the controller 113 shifts the process to step S152.

In step S152, the controller 113 determines whether or not the contents X data are already held in the second memory 104.

In the process, if it is determined that the contents X data are not being held in the second memory 104 (step S152: No), the controller 113, in order to acquire the IP address, which is the location information, of the contents holding terminal apparatus which is holding the contents X data, transmits a search message, which has the contents X contents ID as the destination identification information, based on the routing table stored in the first memory 103. The search message arrives at the contents X root terminal apparatus by means of the DHT routing of the contents distribution system S. In response to the search message, the root terminal apparatus transmits the IP address, which is the location information, of the contents holding terminal apparatus which is holding the contents X data, the controller 113 acquires the IP address, which is the location information, of the contents holding terminal apparatus transmitted from the root terminal apparatus (step S153), and determines whether or not the contents holding terminal apparatus can transmit the contents X data (step S154).

In the process, the controller 113 makes a request, to the contents holding terminal apparatus which is holding the contents X data, for a transmission of the contents X data, and determines whether or not the contents holding terminal apparatus can transmit the contents X data.

If it is determined, in step S154, that the contents holding terminal apparatus can transmit the contents X data (step S154: Yes), the controller 113 shifts the process to step S156.

In step S156, the controller 113, while sequentially receiving the contents X data transmitted by the streaming format from the contents holding terminal apparatus, after decoding with the contents key stored in the contents key storage area of the second memory 104, and stream-reproduces the contents data by operating the video chip 109 and sound source chip 111. Also, the controller 113 sequentially stores the received contents X data in the second memory 104.

When the stream-reproduction of the contents data is finished, the storing of the received contents X data in the second memory 104 is finished, and the saving of the contents X is complete, the controller 113 notifies the contents distribution system S of the matter (step S157). That is, the controller 113, as the contents holding terminal apparatus of the contents X, transmits a registration message to the contents X root terminal apparatus.

Also, if it is determined, instep S154, that the contents holding terminal apparatus cannot carry out the transmission of the contents X data (step S154: No), the controller 113 shifts the process to step S160.

In step S160, the controller 113 requests a transmission of the contents X data from the contents supply apparatus 10 and, while sequentially receiving the contents X data transmitted by the streaming format from the contents supply apparatus 10, in response to the request, after decoding with the contents key stored in the contents key storage area of the second memory 104, and stream-reproduces the contents data by operating the video chip 109 and sound source chip 111 (step S161). Also, the controller 113 sequentially stores the received contents X data in the second memory 104. Subsequently, the controller 113 shifts the process to step S157.

Also, if it is determined, in step S152, that the contents X data are being held in the second memory 104 (step S152: Yes), the controller 113 retrieves the contents X data from the second memory 104 and, after decoding with the contents key stored in the contents key storage area of the second memory 104, and reproduces the contents data by operating the video chip 109 and sound source chip 111 (step S163).

Consequently, when the contents X data corresponding to the user's acquisition request operation are introduced from the contents supply apparatus 10, and its own terminal apparatus is caused to function as the contents holding terminal apparatus, as it is possible to carry out the reproduction of the contents data without carrying out an operation to acquire the contents X data from another contents holding terminal apparatus, it is possible to reduce the process load of the terminal apparatus 1. Also, it is also possible to reduce a load on the network.

Also, if it is determined, in step S151, that the reception of the contents X contents key has not been successful (step S151; No), the controller 113 displays the notification from the contents management apparatus 20 on the built-in display 110 (step S162).

As a case of the reception of the contents X contents key not being successful, there is, for example, an illicit request, or the like. The illicit request meaning that there is no legitimate right with regard to accessing the contents management apparatus 20, it is notified of when, for example, the terminal apparatus 1, having no right to participate in the contents distribution system S, illicitly participates, or when the terminal apparatus 1 has no right to acquire the contents X.

When the processes of steps S157, S162 and S163 are finished, the controller 113 finishes the contents X acquisition and reproduction process.

Next, a specific description will be given, referring to the flowchart of FIG. 17, of the contents transmission process in S131.

As shown in FIG. 17, on the contents transmission process being started, the controller 113 determines whether or not it is possible to transmit the contents data corresponding to the contents transmission request (step S170).

In the process, the controller 113, in response to the contents data transmission request received in step S130, determines whether or not it is possible to transmit the corresponding contents data (step S170).

Herein, the controller 113 determines whether or not it is possible to transmit the corresponding contents data from the process load on the CPU of its own terminal apparatus, a band condition of the network, and the like.

If it is determined, in step S170, that it is possible to transmit the corresponding contents data (step S170: Yes), the controller 113 retrieves the contents data relating to the transmission request from the second memory 104, and transmits them to the terminal apparatus 1 which is the request source (step S171).

Conversely, if it is determined that it is not possible to transmit the corresponding contents data (step S170: No), the controller 113 carries out a transmission impossible notification to the terminal apparatus 1, which is the transmission source, to the effect that it is not possible to transmit the contents data corresponding to the inquiry (step S172).

When the processes of steps S171 and S172 are finished, the controller 113 finishes the contents transmission process.

As heretofore described, when the acquisition request operation by the user has been detected, the terminal apparatus 1 in the embodiment, after acquiring the contents key of the contents data corresponding to the acquisition request operation, from the contents management apparatus 20, via the network, acquires the contents data, and reproduces them.

Description of Contents Supply Apparatus 10 Process Flow

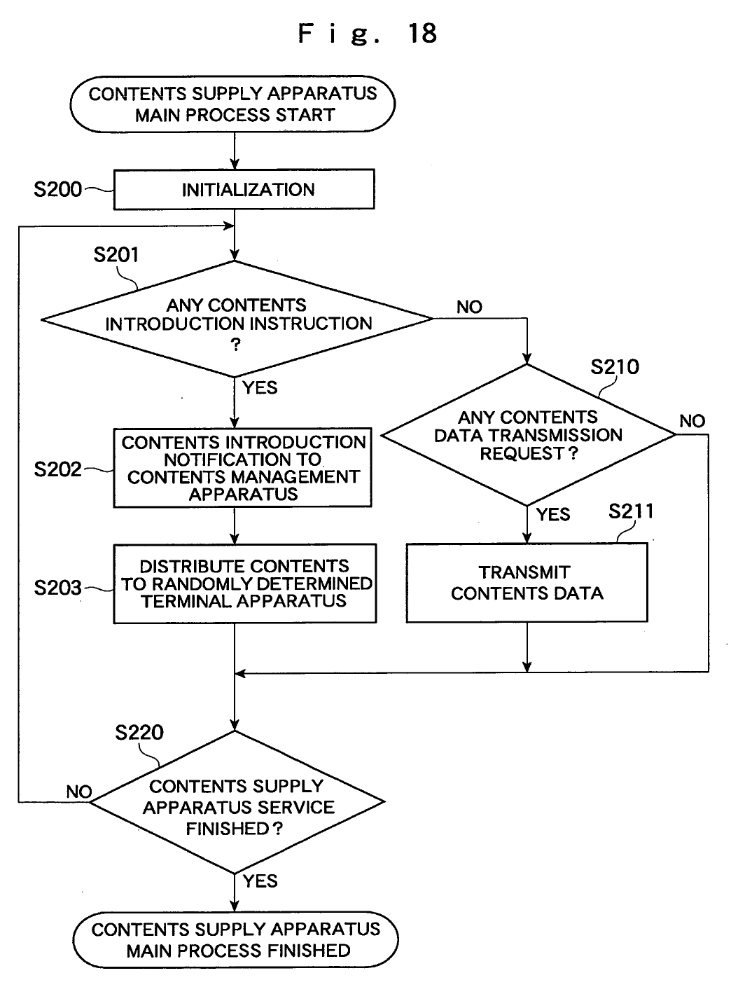

Next, a description will be given, referring to FIG. 18, of a more specific operation of the contents supply apparatus 10. FIG. 18 is a flowchart showing a whole of a process in the contents supply apparatus 10. Each of the following processes is executed by the controller 213 of the contents supply apparatus 10 functioning as the heretofore described units, and the like.

As shown in FIG. 18, on power of the contents supply apparatus 10 being turned on, the CPU 202 of the contents supply apparatus 10 executes initial setting operations, such as permitting an access to the first memory 203 and second memory 204, and initializing a securing of a working area, puts each program 214 to 216 into a condition in which it is executed by the CPU 202 and, after starting up a function as the controller 213 (step S200), moves the process to step S201.

In step S201, the controller 213 determines whether or not there is a contents introduction instruction. Herein, the controller 213 determines whether or not there is a contents introduction instruction based on whether or not a contents introduction operation has been performed, by an operation of an input unit such as the keyboard 207 or the mouse 208, by an operator of the contents distribution system S. The contents introduction instruction is issued, for example, by specifying the contents data by the name of the contents.

In the process, if it is determined that there is a contents introduction instruction (step S201: Yes), the controller 213 carries out a contents introduction notification to the contents management apparatus 20. That is, the controller 213 notifies the contents management apparatus 20 of the name, contents ID, and the like, of the contents corresponding to the contents data specified by the contents introduction instruction (step S202).

Subsequently, the controller 213, in order to make the contents data specified by the contents introduction instruction distributable by the contents distribution system S, randomly determines one or more terminal apparatus 1 to be the contents holding terminal apparatus of the contents data specified by the contents introduction instruction. The controller 213 transmits the contents data specified by the contents introduction instruction, via the network 8, to the terminal apparatus 1 determined in this way (step S203).

Conversely, if it is determined, in step S201, that there is no contents introduction instruction (step S201: No), the controller 213 determines whether or not there is a contents data transmission request from the terminal apparatus 1 (step S210). The contents data transmission request is made by specifying the contents data by the name, contents ID, or the like, of the contents.

In the process, if it is determined that there has been a contents data transmission request from the terminal apparatus 1 (step S210: Yes), the controller 213 retrieves the contents data corresponding to the contents data transmission request from the second memory 204, and transmits them to the terminal apparatus 1 via the network 8 (step S211).

When the processes of steps S203 and S211 are finished, or when it is determined, in step S210, that there is no contents data transmission request from the terminal apparatus 1 (step S210: No), the controller 213 determines whether or not a contents supply apparatus 10 service finishing operation has been carried out (step S220). If it is determined that the service finishing operation has not been carried out (step S220: No), the controller 213 repeats the process from step S201, while if it is determined that the contents supply apparatus 10 service finishing operation has been carried out (step S220: Yes), the controller 213 finishes the process.

In the way heretofore described, the contents supply apparatus 10 notifies the contents management apparatus 20 of the introduced information by transmitting the contents data to the terminal apparatus 1 configuring the contents distribution system S, in accordance with which the contents management apparatus 20 generates and updates the contents list, and transmits it in response to the request from the terminal apparatus 1.

Also, with the contents supply apparatus 10, as it transmits the contents data in response to the request of the terminal apparatus 1, even when it is not possible to acquire the contents data corresponding to the acquisition request operation by the user of the terminal apparatus 1 from another terminal apparatus 1 via the network, it being possible to acquire the contents data corresponding to the acquisition request operation from the contents supply apparatus 10, it is possible to increase a possibility of acquiring the contents data.

Description of Contents Management Apparatus 20 Process Flow

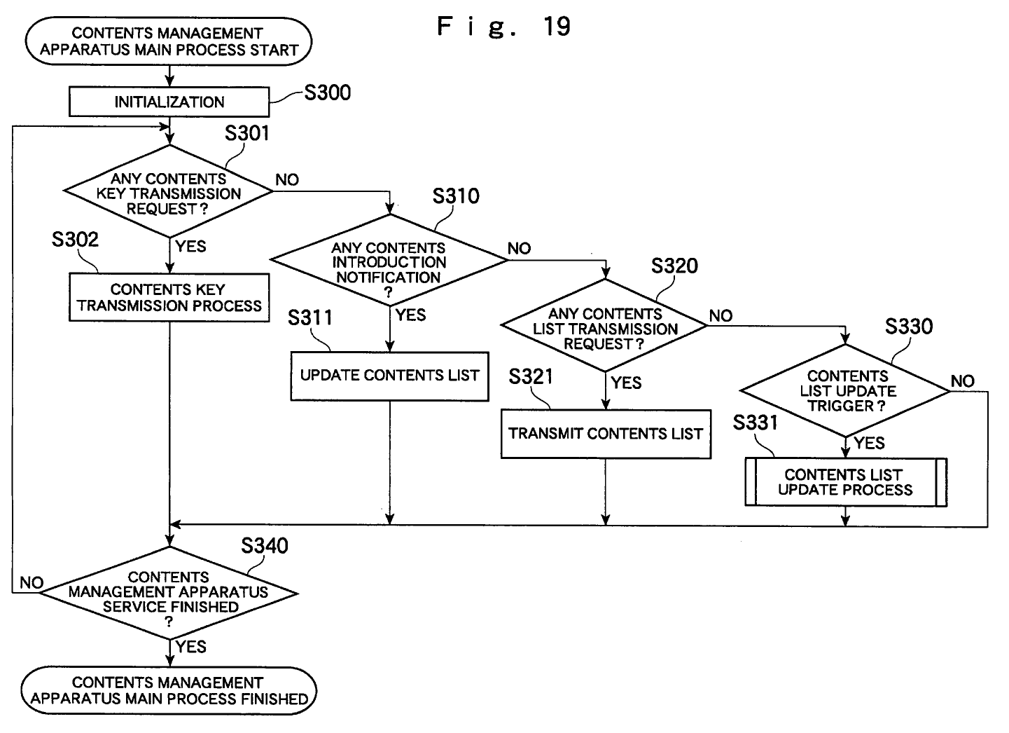

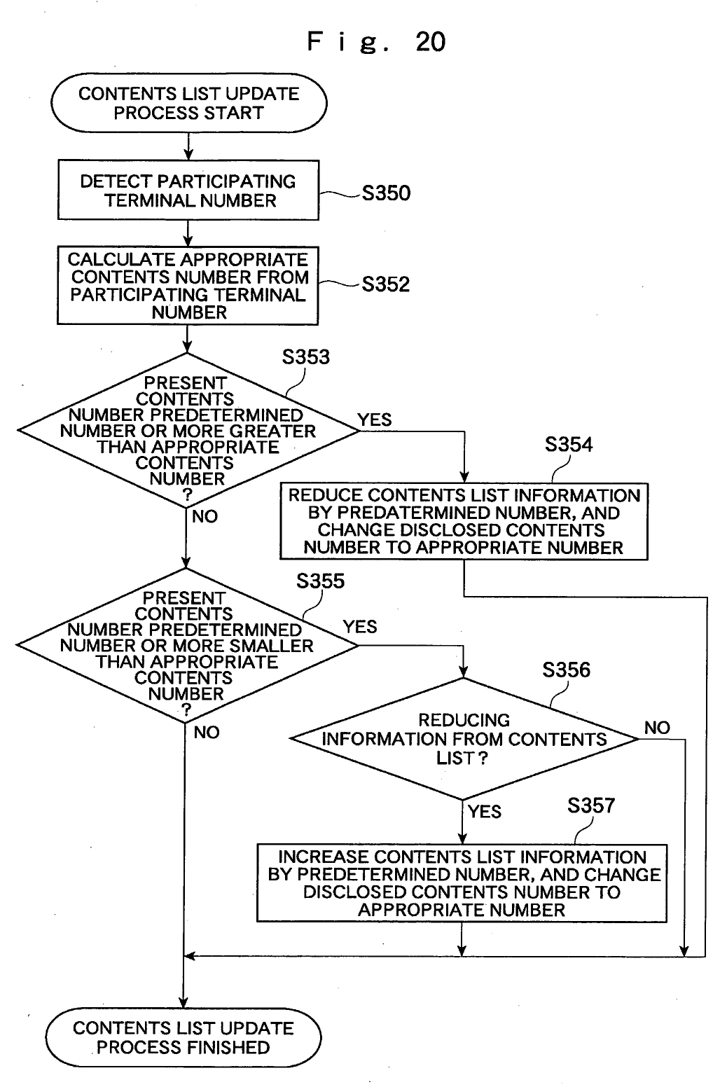

Next, a description will be given, referring to FIGS. 19 and 20, of a more specific operation of the contents management apparatus 20. FIG. 19 is a flowchart showing a whole of a process in the contents management apparatus 20, while FIG. 20 is a flowchart showing a contents list update process. Each of the following processes is executed by the controller 313 of the contents management apparatus 20 functioning as the heretofore described units, and the like.

As shown in FIG. 19, on power of the contents management apparatus 20 being turned on, the CPU 302 of the contents management apparatus 20 executes initial setting operations, such as permitting an access to the first memory 303 and second memory 304, and initializing a securing of a working area, puts each program 314 to 316 into a condition in which it is executed by the CPU 302 and, after starting up a function as the controller 313 (step S300), moves the process to step S301.

In step S301, the controller 313 determines whether or not a contents key transmission request, relating to the contents, has been received from the terminal apparatus 1. In the process, if it is determined that a contents key transmission request relating to the contents X has been received (step S301: Yes), the controller 313 carries out a contents key transmission process (step S302). That is, the controller 313 determines whether or not the terminal apparatus which has requested the contents key is a legitimate terminal apparatus (that is, having a legitimate qualification to participate in the contents distribution system S) and, when it is a legitimate terminal apparatus, transmits the contents X contents key.

Also, if it is determined, in step S301, that no contents key transmission request relating to the contents has been received (step S301: No), the controller 313 determines whether or not there is a contents introduction notification from the contents supply apparatus 10 (step S310). In the process, if it is determined that there has been a contents introduction notification (step S310: Yes), the controller 313 updates the contents list stored in the second memory 204 (step S311). The update of the contents list is carried out by adding to the contents list the information included in the contents introduction notification, that is, the information for specifying the contents data, such as the name of the newly introduced contents.

In step S310, if it is determined that there is no contents introduction notification (step S310: No), the controller 313 determines whether or not there is a contents list transmission request from the terminal apparatus 1 (step S320). In the process, if it is determined that there has been a contents list transmission request from the terminal apparatus 1 (step S320: Yes), the controller 313 retrieves the contents list from the second memory, and transmits the contents list to the terminal apparatus 1 which is the request source (step S321).

Conversely, if it is determined, instep S320, that there is no contents list transmission request from the terminal apparatus 1 (step S320: No), the controller 313 determines whether or not a contents list update trigger has come around (step S330). In the process, if it is determined that the contents list update trigger has come around (step S330: Yes), the controller 313 carries out the contents list update process (step S331). The process of step S331, being processes S350, and S352 to S357, in FIG. 20, will be described in detail hereafter. The contents list update trigger being set at a timing of a predetermined interval (for example, every three minutes), the controller 313 carries out a time count and, when a predetermined counter value is arrived at, determines that the contents list update trigger has come around.

When the processes of steps S302, S311, S321 and S331 are finished, or when it is determined that the contents list update trigger has not come around (step S330: No), the controller 313 determines whether or not a contents management apparatus 20 service finishing operation has been carried out (step S340). If it is determined that the service finishing operation has not been carried out (step S340: No), the controller 313 repeats the process from step S301, while if it is determined that the contents management apparatus 20 service finishing operation has been carried out (step S340: Yes), the controller 313 finishes the process.

Next, a specific description will be given, referring to the flowchart of FIG. 20, of the contents list update process in S331.

As shown in FIG. 20, on the contents list update process being started, the controller 313 detects the participating terminal number (step S350). The detection of the participating terminal number is carried out, as heretofore described, by calculating an estimated value from the condition of the routing tables of the terminal apparatus 1 participating in the contents distribution system S.

Next, the controller 313 calculates an appropriate disclosed contents number (the appropriate contents number) from the participating terminal number (step S352), and shifts the process to step S353. Also, the controller 313 calculates the number of contents data (the present contents number) which can be transmitted and received among the terminal apparatus of the contents distribution system S at the present moment. As these calculations have been described heretofore, a description will be omitted.

In step S353, the controller 313 determines whether or not the present contents number is a predetermined number or more greater than the appropriate contents number. In the process, if it is determined that the present contents number is the predetermined number or more greater than the appropriate contents number (step S353: Yes), the controller 313 reduces the number of contents data included in the contents list (the included contents number) by a predetermined number, thus reducing the disclosed contents number, which is the number of contents data which can be transmitted and received among the terminal apparatus (step S354).

In this way, as the controller 313 reduces the contents data included in the contents list by the predetermined number when the present contents number is the predetermined number or more greater than the appropriate contents number, it is possible to reduce the contents data transmission requests from the terminal apparatus 1 to the contents management apparatus 20.

If it is determined, in step S353, that the present contents number is not the predetermined number or more greater than the appropriate contents number (step S353: No), the controller 313 determines whether or not the present contents number is a predetermined number or more smaller than the appropriate contents number (step S355). In the process, if it is determined that the present contents number is the predetermined number or more smaller than the appropriate contents number (step S355: Yes), the controller 313, furthermore, determines whether or not it is a condition in which the information is being reduced in the contents list (step S356). Herein, “a condition in which the information is being reduced in the contents list” means that there are contents data, among the contents data in the contents distribution system S, which are not included in the contents list.

If it is determined, in step S356, that it is the condition in which the information is being reduced in the contents list (step S356: Yes), the controller 313 increases the number of contents data included in the contents list (the included contents number) by a predetermined number, thus increasing the number of contents data which can be transmitted and received among the terminal apparatus (step S357). In other words, the included contents number reduced in step S355 is restored by the predetermined number.

In this way, as the contents data included in the contents list are increased by the predetermined number when the present contents number is the predetermined number or more smaller than the appropriate contents number, it is possible to restore, by the predetermined number, the included contents number reduced when the present contents number becomes the predetermined number or more greater than the appropriate contents number. Consequently, after the present contents number becomes the predetermined number or more greater than the appropriate contents number, when the number of terminal apparatus 1 participating in the contents distribution system S increases, and becomes an appropriate number in relation to the number of contents data in the contents distribution system S, and the like, it is possible to provide a contents list in which all of the contents data in the contents distribution system S are included.

When the processes of steps S354 and S357 are finished, when it is determined that the present contents number is not the predetermined number or more smaller than the appropriate contents number (step S355: No), and when it is determined that it is not the condition in which the information is being reduced in the contents list (step S356: No), the controller 313 finishes the contents list update process.

As heretofore described, the contents management apparatus 20 in the embodiment, based on the participating terminal number, changing the disclosed contents number, which is the number of contents data which can be transmitted and received among the terminal apparatus, and reducing the contents supply apparatus 10 server load condition, it is possible to take measures in advance against problems such as the contents supply apparatus 10 crashing due to overloading.

### 2. Second Embodiment

Next, a description will be given of a second embodiment according to the invention. Although a contents distribution system of the second embodiment is configured, in the same way as in the first embodiment, of the terminal apparatus 1, the contents supply apparatus 10, and the contents management apparatus 20, a method of adjusting the number of contents data which can be transmitted and received among the terminal apparatus (the disclosed contents number) is different from that of the first embodiment. That is, in the first embodiment, the changing of the number of contents data which can be transmitted and received among the terminal apparatus is carried out by adjusting the number of contents data included in the contents list, but in the second embodiment, the disclosed contents number is changed by restricting the transmission of the contents key.

The reduction of the disclosed contents number by the contents management apparatus 20 is carried out by restricting the transmission of the contents key by a predetermined rate. For example, it is arranged in such a way as, at a rate of once every three times, not to carry out the transmission of the contents key in response to a request for the contents key. By this means, it is possible to essentially reduce the disclosed contents number by one third. Also, it is also acceptable, by adjusting a period for which the transmission of the contents key is not carried out in response to a request for the contents key, to essentially reduce the disclosed contents number.

Also, the increase of the disclosed contents number by the contents management apparatus 20 is carried out by relaxing or removing the restriction on the transmission of the contents key. For example, it is possible to essentially increase the disclosed contents number by one sixth by changing from the condition in which, at the rate of once every three times, the transmission of the contents key in response to a request for the contents key is not carried out (the transmission restriction), to a transmission restriction condition of a rate of once every six times.

In a condition in which the contents key transmission restriction is not being imposed, it is not possible to carry out the increase of the disclosed contents number by the contents key transmission restriction. Therein, in the same way as in the first embodiment, it is arranged in such a way that it is possible to set in such a way that the contents management apparatus 20 requests the contents supply apparatus 10 to transmit, or additionally introduce, a number of contents data corresponding to an increase in the necessary disclosed contents number. In response to the request, the contents supply apparatus 10 transmits, or introduces, the contents data to a plurality of terminal apparatus.

As the configuration and operations of the terminal apparatus 1 and contents supply apparatus 10 in the contents distribution system of the second embodiment are the same as those described in the first embodiment, a description thereof will be omitted here. Herein, in order to facilitate the description, reference numbers identical to the reference numbers attached to each apparatus in the first embodiment will be used.

### 2.1. Description of Configuration and the Like of Contents Management Apparatus 20

Firstly, a description will be given of a configuration of the contents management apparatus 20 of the second embodiment. As the contents management apparatus 20 of the second embodiment, apart from the details of the contents adjustment program 316 being partly different, is no different from that of the first embodiment, only particularly different portions will be described herein.

In the same way as in the first embodiment, the CPU 302, by executing the contents adjustment program 316, functions as the terminal apparatus number detection unit, contents number determination unit, contents number adjustment unit, and the like. As the terminal apparatus number detection unit and contents number determination unit are the same as the functions described in the first embodiment, the contents number adjustment unit will be described herein.

Contents Number Adjustment Unit

The contents number adjustment unit changes the number of contents data which can be transmitted and received among the terminal apparatus 1 (the disclosed contents number) in accordance with the number of contents data determined by the contents number determination unit (the appropriate contents number). For example, in the event that it is determined that the number of contents data which can be transmitted and received among the terminal apparatus of the contents distribution system S at the present moment (the present contents number) is a predetermined number or more greater than the appropriate contents number, the contents number adjustment unit reduces the disclosed contents number by a predetermined number. Also, in the event that it is determined that the present contents number is a predetermined number or more smaller than the appropriate contents number, the contents number adjustment unit increases the disclosed contents number by a predetermined number.

Herein, the changing of the disclosed contents number is carried out by means of an adjustment of the contents key transmission restriction by the key information provision unit.

Firstly, the key information provision unit receives a request for the contents key from the terminal apparatus 1. At this time, depending on the participating terminal number, the key information provision unit determines whether or not to carry out the transmission of the contents key. Specifically, it determines whether or not the present contents number is the predetermined number or more smaller than, or greater than, the appropriate contents number. Herein, although the “present contents number” is obtained by the contents number adjustment unit calculating based on the number, timing and viewing rate (the estimated value of the transmission and reception rate of the contents data) of all the contents data introduced into the contents distribution system S by the contents supply apparatus 10, as well as on a contents key transmission restriction value, to be described hereafter, it is also acceptable to calculate using another parameter. Also, it is also acceptable to arrange in such a way that the terminal apparatus 1 holding the contents data is caused to regularly report on details held, and the contents number adjustment unit gathers the details, and calculates them as the present contents number.

Next, when the present contents number is within a predetermined range, with the appropriate contents number as a reference, the key information provision unit retrieves the contents key corresponding to the request from the second memory 304, and transmits it to the terminal apparatus 1 which is the request source. The contents ID corresponding to the request being included in the contents key request from the terminal apparatus 1, the key information provision unit retrieves the contents key corresponding to the contents ID from the contents key database of the second memory 304.

Conversely, when the present contents number is the predetermined number or more greater than the appropriate contents number, the key information provision unit, without carrying out the transmission of the contents key, refuses the contents key request at a predetermined rate. By this means, it is possible to reduce the disclosed contents number by the heretofore mentioned predetermined rate. For example, from among five contents key requests, the key information provision unit transmits a message refusing the transmission of the contents key in response to one contents key request while, in response to four contents key requests, it retrieves the contents key corresponding to the request from the second memory 304, and transmits it to the terminal apparatus 1 which is the request source. By this means, it is possible to reduce the disclosed contents number to four fifths.

Also, in the condition in which the transmission of the contents key is refused at the predetermined rate in this way, when the present contents number is the predetermined number or more greater than the appropriate contents number, the key information provision unit increases the rate of refusing the transmission of the contents key. For example, when the present contents number is still the predetermined number or more greater than the appropriate contents number, even after reducing the disclosed contents number to four fifths, as heretofore described, the key information provision unit further increases the rate of refusing the transmission of the contents key. For example, from among five contents key requests, the key information provision unit transmits a message refusing the transmission of the contents key in response to two contents key requests.

Also, in the condition in which the transmission of the contents key is refused at the predetermined rate, when the present contents number is the predetermined number or more smaller than the appropriate contents number, the key information provision unit reduces the rate of refusing the transmission of the contents key. For example, when reducing the disclosed contents number to three fifths, as heretofore described, when the contents supply apparatus 10 server load condition is below a predetermined lower limit, the key information provision unit changes the rate of refusing the transmission of the contents key so as to transmit a message refusing the transmission of the contents key in response to only one contents key request, from among five contents key requests.

As the contents management apparatus 20 in the embodiment increases or decreases the disclosed contents number by increasing or decreasing the rate of refusing the transmission of the contents key in this way, it does not happen that the process becomes complicated.

Also, it is also acceptable to arrange in such a way that, rather than increasing or decreasing the rate of refusing the transmission of the contents key, as heretofore described, all transmissions of the contents key are refused when the contents supply apparatus 10 server load condition exceeds a predetermined upper limit.

Also, it is also acceptable to arrange in such a way that, rather than refusing the transmission of the contents key, the contents key transmission requests are stocked, and a timing of transmitting the contents key is delayed.

### 2.2. Description of Contents Management Apparatus 20 Process Flow

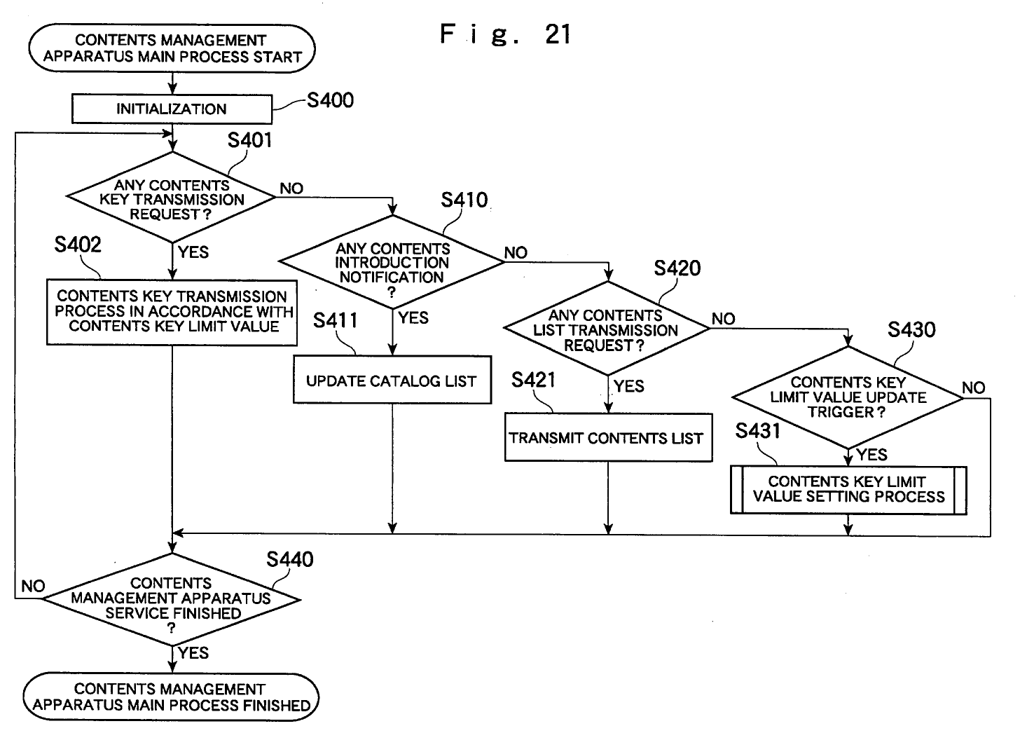

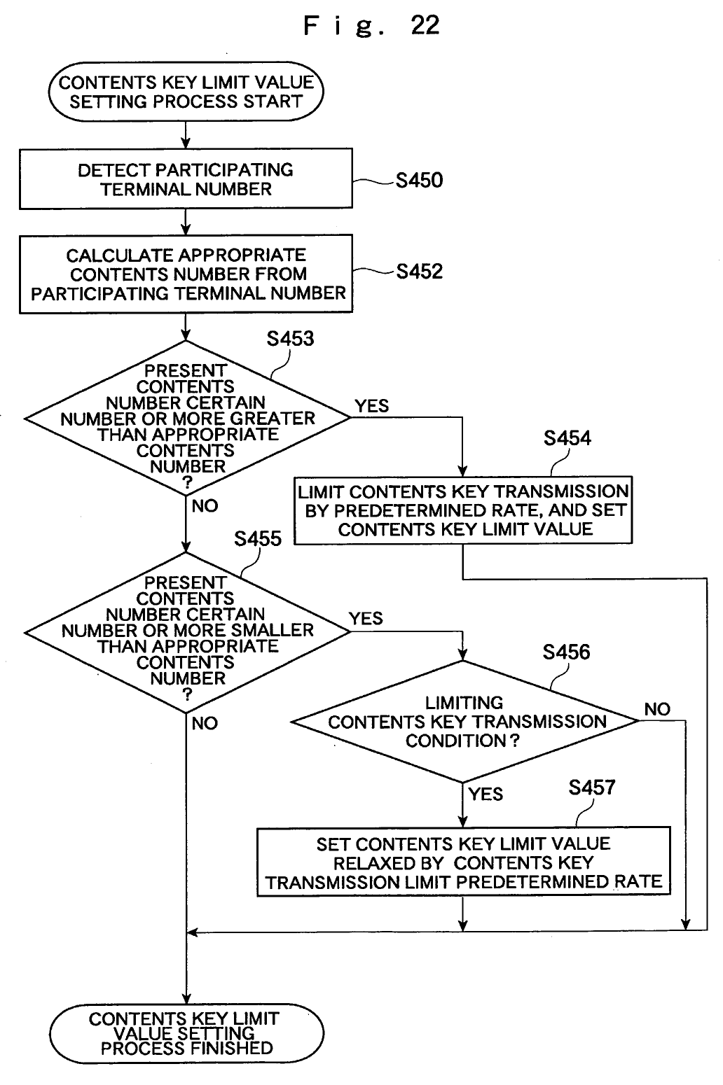

Next, a description will be given, referring to FIGS. 21 and 22, of a more specific operation of the contents management apparatus 20. FIG. 21 is a flowchart showing a whole of a process in the contents management apparatus 20 of the second embodiment, while FIG. 22 is a flowchart showing a contents list update process of the second embodiment. Each of the following processes is executed by the controller 313 of the contents management apparatus 20 functioning as the heretofore described units, and the like.

Firstly, a description will be given, referring to FIG. 21, of a main process in the contents management apparatus 20. As the processes of step S202 and step S402, the processes of step S230 and step S430, and the processes of step S231 and step S431, in the flowchart shown in FIG. 21 and the flowchart shown in FIG. 19, are different, but the other processes are the same, a description will be given here of only steps S402, S430 and S431.

As shown in FIG. 21, if it is determined, in step S401, that there is a contents introduction instruction (step S401: Yes), the controller 313 determines a possibility of transmitting the contents key in accordance with the contents key restriction value, to be described hereafter, stored in the first memory 303 and, in a case of transmitting the contents key, transmits the contents key to the terminal apparatus 1 which is the request source. Conversely, in a case of refusing without carrying out the transmission of the contents key, the controller 313 notifies the terminal apparatus which is the request source of the matter (step S402). In this way, the disclosed contents number is changed by carrying out the contents key transmission restriction in accordance with the contents key restriction value.

Also, in step S430, it is determined whether or not an update trigger of the contents key restriction value has come around. In the process, if it is determined that the update trigger of the contents key restriction value has come around (step S430: Yes), the controller 313 carries out a contents key restriction value setting process (step S431).

The process, being a process specifically shown in S450, and S452 to S458 in FIG. 22, will be described hereafter, referring to FIG. 22. As the processes of step S354 and step S454, the processes of step S356 and step S456, and the processes of step S357 and step S457, in the flowchart shown in FIG. 22 and the flowchart shown in FIG. 20, are different, but the other processes are the same, a description of the other processes will be omitted here, and a description will be given of steps S454, S456 and S457.

As shown in FIG. 22, if it is determined, in step S453, that the present contents number is a predetermined number or more greater than the appropriate contents number (step S453: Yes), the controller 313 sets a contents key restriction value which restricts the transmission of the contents key by a predetermined rate, as heretofore described (step S454).

Also, if it is determined, in step S455, that the present contents number is a predetermined number or more smaller than the appropriate contents number (step S455: Yes), the controller 313 determines whether or not the contents management apparatus 20 is in a condition in which it is restricting the transmission of the contents key (step S456). In the process, if it is determined that the contents key transmission restriction is being imposed (step S456: Yes), the controller 313 sets a contents key restriction value whereby the contents key transmission restriction is relaxed by a predetermined rate, as heretofore described (step S457).

When the processes of steps S454 and S457 are finished, when it is determined that the contents key transmission restriction is not being imposed (step S456: No), or when it is determined that the present contents number is not the predetermined number or more smaller than the appropriate contents number (step S455: No), the controller 313 finishes the contents list update process.

As heretofore described, the contents management apparatus 20 in the embodiment, based on the participating terminal number, changing the disclosed contents number, which is the number of contents data which can be transmitted and received among the terminal apparatus, and reducing the contents supply apparatus 10 server load, by carrying out the contents key transmission restriction, it is possible to take measures in advance against problems such as the contents supply apparatus 10 crashing due to overloading.

Also, in the heretofore described first and second embodiments, a description is given of an aspect in which the contents key is transmitted from the contents management apparatus 20 to the terminal apparatus 1, but in the case of carrying out the change of the disclosed contents number, which is the number of contents data which can be transmitted and received among the terminal apparatus, by means of the contents list, it is also possible to have a contents distribution system which does not use the contents key. In this case, as the processes of FIGS. 8-2 to 8-4 do not need to be carried out, the contents data acquisition and reproduction process becomes simpler.

Also, in the first and second embodiments, the contents supply apparatus 10 and contents management apparatus 20 are described as separate apparatus but, not being limited to this, it is also acceptable that they are an integrated server apparatus. That is, any kind of configuration is acceptable, as long as it can execute the functions of the contents supply apparatus 10 and the functions of the contents management apparatus 20.

Also, in the first and second embodiments, a description is given with the format of transmitting and receiving the contents data among the terminal apparatus 1 as the streaming format but, not being limited to this, it is also acceptable that it is a download format.

Also, in the first and second embodiments, a description is given of the example in which the contents key is a decoding key for decoding the contents data but, not being limited to this, it is also acceptable, for example, to arrange in such a way that it is used when the request terminal apparatus acquires the contents data from the contents holding terminal apparatus. For example, the contents holding terminal apparatus, when a correct contents key is transmitted to it, transmits the contents data to the request terminal apparatus. In this case, the information corresponding to the contents key being stored in the contents data, the request terminal apparatus, when the information and the contents key transmitted from the request terminal apparatus match, transmits the contents data to the request terminal apparatus.

Although the embodiment and modification of the present invention have been described in detail herein, the scope of the invention is not limited thereto. It will be appreciated by those skilled in the art that various modifications may be made without departing from the scope of the invention. Accordingly, the embodiment and modification disclosed herein are only exemplary. It is to be understood that the scope of the invention is not to be limited thereby, but is to be determined by the claims which follow.

What is claimed is:

1. A contents management apparatus which manages contents in a contents distribution system, configured of a plurality of terminal apparatus disposed in a network, which carries out a transmission and reception of contents data among the terminal apparatus, comprising:
a terminal apparatus number detection unit which detects a number of the terminal apparatus configuring the contents distribution system;
a contents number determination unit which determines a number of contents data which can be transmitted and received among the terminal apparatus, based on the number of the terminal apparatus detected by the terminal apparatus number detection unit; and
a contents number adjustment unit which changes the number of contents data which can be transmitted and received among the terminal apparatus, in accordance with the number of contents data determined by the contents number determination unit.

2. The contents management apparatus according to claim 1, further comprising:
a storage unit in which is set a transmission and reception rate of the contents data predicted for every unit time, wherein
the contents number determination unit determines the number of contents data which can be transmitted and received among the terminal apparatus, based on the number of the terminal apparatus detected by the terminal apparatus number detection unit, and on the transmission and reception rate set in the storage unit.

3. The contents management apparatus according to claim 1, wherein
the terminal apparatus number detection unit detects a change in the number of the terminal apparatus configuring the contents distribution system every predetermined interval,
the contents number determination unit determines a number by which to increase or decrease the contents data which can be transmitted and received among the terminal apparatus, in accordance with the change in the number of the terminal apparatus detected by the terminal apparatus number detection unit, and
the contents number adjustment unit changes the number of contents data which can be transmitted and received among the terminal apparatus, in accordance with the number, determined by the contents number determination unit, by which the contents data is to be increased or decreased.

4. The contents management apparatus according to claim 3, further comprising:
a table in which are correlated the number of the terminal apparatus and the number of contents data, wherein
the contents number determination unit, based on the table, determines the number by which to increase or decrease the contents data which can be transmitted and received among the terminal apparatus.

5. The contents management apparatus according to claim 1, further comprising:
a contents list provision unit which provides the terminal apparatus with a contents list, which is a list of contents data which can be transmitted and received among the terminal apparatus, used in the terminal apparatus in order to carry out a transmission and reception of the contents data among the terminal apparatus, wherein
the contents number adjustment unit, by changing the contents list, changes the number of contents data which can be transmitted and received among the terminal apparatus.

6. The contents management apparatus according to claim 1, further comprising:
a key information provision unit which transmits key information for reproducing the contents data in the terminal apparatus, in response to a request from the terminal apparatus, wherein
the contents number adjustment unit, by controlling the key information provision unit to restrict the transmission of the key information, changes the number of contents data which can be transmitted and received in the contents distribution system.

7. A recording medium on which is recorded a program for causing a computer to function as each unit according to claim 1.

8. A contents distribution system, configured of a plurality of terminal apparatus disposed in a network, which carries out a transmission and reception of contents data among the terminal apparatus, comprising:
a contents supply apparatus including a contents supply unit which, in response to a request from a terminal apparatus which cannot acquire desired contents data from another terminal apparatus, transmits the contents data, via the network, to the terminal apparatus which has made the request; and
a contents management apparatus which changes the number of contents data which can be transmitted and received among the terminal apparatus, wherein
the contents management apparatus includes:
a terminal apparatus number detection unit which detects a number of the terminal apparatus configuring the contents distribution system;
a contents number determination unit which determines a number of contents data which can be transmitted and received among the terminal apparatus, based on the number of the terminal apparatus detected by the terminal apparatus number detection unit; and
a contents number adjustment unit which changes the number of contents data which can be transmitted and received among the terminal apparatus, in accordance with the number of contents data determined by the contents number determination unit.

9. The contents distribution system according to claim 8, wherein the contents management apparatus, further including:
a contents list provision unit which provides the terminal apparatus with a contents list, which is a list of contents data which can be transmitted and received among the terminal apparatus, used in the terminal apparatus in order to carry out a transmission and reception of the contents data among the terminal apparatus,
carries out a change of the number of contents data which can be transmitted and received among the terminal apparatus by changing the contents list.

10. The contents distribution system according to claim 8, wherein the contents management apparatus, further including:
a key information provision unit which transmits key information for reproducing the contents data in the terminal apparatus, in response to a request from the terminal apparatus,
carries out a change of the number of contents data which can be transmitted and received among the terminal apparatus by restricting the transmission of the key information.

11. An information processing method in a contents distribution system configured of a plurality of terminal apparatus disposed in a network, which carries out a transmission and reception of contents data among the terminal apparatus, comprising:
a step of detecting a number of the terminal apparatus configuring the contents distribution system;
a step of determining a number of contents data which can be transmitted and received among the terminal apparatus, based on the detected number of the terminal apparatus; and
a step of changing the number of contents data which can be transmitted and received among the terminal apparatus, in accordance with the determined number of contents data.
